(19) United States
(12) Patent Application Publication
(10) Pub. No.: US 2019/0073827 A1
(43) Pub. Date: Mar. 7, 2019

(54) Method and System for Converting 3-D Scan Displays with Optional Telemetrics, Temporal and Component Data into an Augmented or Virtual Reality BIM

(71) Applicant: Josen Premium LLC, Miami, FL (US)

(72) Inventors: Daniel Coronado, Miami, FL (US); Ysaac Coronado, Miami, FL (US); Roberto Jose Ocando Morales, Pueblo Nuevo de Paraguana (VE)

(21) Appl. No.: 15/696,986

(22) Filed: Sep. 6, 2017

(51) Int. Cl. G06T 19/00; G06T 7/00; G06T 13/20; G06T 7/62

(52) U.S. Cl. CPC G06T 19/003; G06T 19/006; G06T 7/001; H04Q 9/00; G06T 7/62; G06T 2207/10028; G06T 13/20

(57) ABSTRACT

An augmented-virtual reality (V) system-method permits users to interact with displayed static (S) and dynamic (D) components in a building information model (“BIM”) having S-D data component tables. Realtime telemetric data in the D-tables is viewable with the spatially aligned V-BIM (aligned with 3-D facility scans). On command, the user views V-BIM-realtime, V-BIM-static, as-is visual 3-D scan, and S-D data component tables showing then-current telemetric data. A compatible BIM is created from a library of BIM data objects or P&ID. Insulation is virtually removed in the V-BIM using pipe flange thickness processed by the system from the as-is scan. D-tables include key performance indicators. With no telemetrics, user can display: V-BIM, S-D tables, as-is scan. With 3-D over two timeframes, V-BIM-t1 created by two static components, V-BIM-t2 created by V-BIM-t1 and a third static component, and a fully functional V-BIM with estimated BIM data is created.

The present invention relates to a system and a method for converting 3-D as-is scan data into either an augmented (AR) or virtual reality (VR) display presentations of a building information model (“BIM”) which spatially matches the 3-D scan data. Various modules enable the user to integrate telemetric data into the AR or VR BIM presentation or to integrate temporal data which is based upon 3-D scan data obtained at two disparate time frames. The telemetric data is converted into dynamic component data and the user can view the dynamic data by activating a data object link on the visually presented component in the BIM virtual display. With respect to the temporal data, two compatible BIM models or plans are generated over two disparate time frames and these two BIM models are spatially aligned to create the virtual reality BIM data. The present invention handles AR and VR data for industrial plant facilities, industrial processing platforms, commercial sites, floating production storage and offloading vessels, maritime vessels in heritage archaeological sites, herein identified as “monitored facilities”.

### BACKGROUND OF THE INVENTION

Building information models or theme are oftentimes used in connection with the construction and build out of industrial plant facilities, industrial processing platforms, commercial sites, floating production storage and offloading vessels and maritime vessels. The use of computer aided manufacturing (CAM) and computer aided design (CAD) software enables designers to sometimes generate BIM models of facilities or vessels or sites. These BIM models can be viewed from many different perspectives or viewpoints. Also, the user, when the BIM model is displayed, can zoom in on one or more component shown on the BIM display model.

However, the BIM models and the CAD/CAM models utilized during the build out of the facility oftentimes do not accurately show the facility as-built. The contractors building the facility may mark up these BIM or CAD drawings. These modified drawings are called “markup BIM drawings” and show the facility in what the builder or the facility owner believes represents an as-is BIM drawing. It is customary that the facility be constructed within “substantial completion” specifications unless the original architectural and engineering plans call for exact specifications on certain compliments or floor plans. Therefore, oftentimes the as-is facility does not match the BIM plans.

Also, these facilities are subject to renovation, modification and repair. Sometimes these renovations, modifications and repairs are not reflected on updated version of the BIM model drawings.

Therefore there are several problems associated with the current operating state of these facilities, the initial and modified BIM drawings and plans for these facilities. For example, to engage in a repair operation, it may be critical to have a 3-D scan of the facility or a 3-D scan particular floor or deck in the facility, identifying the exact dimensions of doorways, entranceways and exits, in the exact location of hallways or walkways, piping process, vessels and various physical components on the facility floor or deck. In a repair operation, the physical component to be repaired or modified must be clearly identified, the repair on that item be identified, the equipment needed to be placed on the deck or floor identified, information regarding logistics of delivering the equipment to the floor or deck of the facility, and the downtime or effect of removing that particular component from the facility's production process must be analyzed. These disparate informational elements cause any repair and replacement operation to be handled on an ad hoc basis. The present invention seeks to solve this ad hoc repair, replacement and renovation process by integrating an as-is scan data with current or updated BIM models and providing detailed static component data tables and dynamic component data tables.

Another problem associated with prior art systems is that very few of these systems integrate currently acquired as-is 3-D scans and BIM data which is spatially aligned to the physical location of the physical components. The physical plant is captured in the 3-D as-is scan.

A further problem with prior art systems is that certain physical components in these monitored facilities are hidden by insulation or other types of enclosures. Therefore, an analysis regarding maintenance and improvement in plant production whether to achieve a reduction in input resources or an optimization of plant processes and efficient use of input resources as compared with plant output is difficult because these physical components are hidden by insulation. The present invention includes a module which eliminates the outer layer of insulation on the physical component and shows the CPT in the virtual BIM display. For example, if the physical component is a pipe, and the pipe is covered with a layer of insulation, the present system utilizes algorithms to estimate the outer diameter of the pipe and the inner diameter of the pipe.

Another problem with the prior art systems is that these systems cannot show the as-is scan data substantially concurrently with the current BIM model data. Typically, there are several engineers and plant managers and contractors using the as-is scan data and the BIM model in group discussions. In discussions regarding where a particular physical complement is located on the plant floor or deck, it is helpful to have both the as-in scan data shown as augmented reality or virtual reality data presentation effectively side-by-side next to the BIM model augmented or virtual reality data. In this manner, the physical location of the physical component can be quickly identified and, if necessary, the BIM model can be altered such that the BIM model spatially matches the as-is scan data.

An additional problem with the prior art is that studies cannot be conducted on the augmented or virtual reality prior art BIM models because those BIM models do not have associated component data tables representing both static component elements and dynamic and more changeable component information. With the present inventive techniques and systems, virtual testing and improvement can be conducted on the virtual reality BIM model prior to changing the control points in the facility.

With respect to archaeological heritage sites, the use of virtual reality BIM models are created by on-site 3D scans taken over different disparate time frames. This enables the user to project an estimate of missing elements from the heritage site. By estimating these missing elements from the heritage site, the user, such as an archaeologist, can adjust his or her excavation of the site.

U.S. Pat. No. 9,619,944 discloses a coordinate geometry augmented reality process for internal elements concealed the behind external building elements. Internal elements concealed behind an external building element can be visualized in a live view. The view is aligned to the orientation and scale of the scene displayed. The markers are placed on the external element. This marker enables the orientation size to be altered to reveal hidden building elements such as electrical and plumbing, behind external element such as a building wall.

U.S. Pat. No. 9,424,371 discloses a click-to-accept as-built model. A CAD drawing of a project and a digital representation of the physical implementation of the project is obtained. A relationship that matches and maps the digital representation to the CAD drawing is defined and established. A compound of the digital representation is identified based on the relationship in a database and catalog. Information about the identified compound is transmitted to and displayed in a computer.

U.S. Pat. No. 9,342,928 discloses a system and method for presenting building information. The technology discloses a relationship between BIM data which includes building schematics and standardize three-dimensional models and a building management system data. The building system management data includes heating, ventilation and air conditioning components and similar engineering drawings. Maps are created including the location of equipment defined in both the BIM model and the building management system data model. Augmented reality technology is applied.

As used herein, the term “virtual reality display” and, more generally, “virtual reality” is meant to cover a broad-based definition of “virtual reality.” Merriam-Webster defines virtual reality as: “an artificial environment which is experienced through sensory stimuli (such as sights and sounds) provided by a computer and in which one's actions partially determine what happens in the environment;” and, also “the technology used to create or access a virtual reality”. Dictionary.com defines virtual reality as: “a realistic and immersive simulation of a three-dimensional environment, created using interactive software and hardware, and experienced or controlled by movement of the body.” Gartner's IT Glossary (an online dictionary at www.gartner.com) defines virtual reality as: “Virtual reality (VR) provides a computer-generated 3D environment that surrounds a user and responds to that individual's actions in a natural way, usually through immersive head-mounted displays and head tracking. Gloves providing hand tracking and haptic (touch sensitive) feedback may be used as well. Room-based systems provide a 3D experience for multiple participants; however, they are more limited in their interaction capabilities.” The Cambridge Dictionary defines virtual reality as: “a set of images and sounds, produced by a computer, that seem to represent a place or a situation that a person can take part in”. A text by Philippe Fuchs, “Virtual Reality: Concepts and Technologies”, pg. 8, July 2011 by CRC Press, states: “Virtual reality is a scientific and technical domain that uses computer science and behavioral interfaces to simulate in a virtual world the behavior of 3D entities, which interact in real time with each other and with one or more users in a psuedo-natural immersions via sensorimotor channels.” The Fuchs book is a manual for both designers and users, comprehensively presenting the current state of experts' knowledge on virtual reality (VR) in computer science, mechanics, optics, acoustics, physiology, psychology, ergonomics, ethics, and related area. Therefore, as used herein the term “virtual reality” is meant to cover the broadest definition discussed above (for example, “virtual reality is a scientific and technical domain that uses computer science and behavioral interfaces to simulate in a virtual world the behavior of 3D entities” or “a set of images and sounds, produced by a computer, that seem to represent a place or a situation that a person can take part in”). Further the term “virtual reality display” is meant to cover any type of computer monitor or display which interfaces with one or more users to simulate, in a virtual setting, the behavior of a 3D entity (the monitored facility), without regard to whether the computer display or monitor is a flat screen monitor, a curved monitor, a 3D monitor, a tablet computer, a smart phone display, head gear type glasses (typically an augmented reality device, e.g., Google Glass™), or head gear carried on the head of the user that substantially immerses the user with the displayed images. The term “virtual reality” includes “augmented reality” (since the primary difference in the embodiments described herein is the use of glasses or a display monitor rather than the more typical “virtual reality head gear”) and further includes “mixed reality” and “hybrid reality.”

### OBJECTS OF THE INVENTION

It is an object of the present invention to provide a method for integrating substantially real time telemetric data into a building information model BIM which is then presented as an augmented reality display or a virtual reality display to one or more users.

It is another object of the present invention to provide a system to eliminate covers over physical components such as insulation over piping and once that information regarding the insulated pipe is obtained, to alter the virtual reality BIM data to represent the pipe without the insulation as actually physically found on the facility platform, floor or deck. In this manner, the BIM model closely if not exactly represents the physical attributes of the static and dynamic components utilized in the monitored facility.

Is a further object of the present invention to provide the user with the ability to display both the BIM data and the as-is data with the current display of static component data tables and dynamic component data tables. In this manner, users who view this augmented reality or virtual reality display can plan for maintenance, renovation, improve processes, increase efficiency and handle other key performance indicators.

A further object of the present invention provides for integrating temporal data into the BIM model based upon first and second temporal 3-D scans obtained over corresponding disparate time frames. These time-based 3-D scans are spatially aligned with respect to each other and static components are identified and at least one dynamic component is identified in order to display augmented reality or virtual reality displays of both a dynamic component, the static component and the virtual reality BIM model.

An additional object of the present invention is to provide an online system integrating substantially real time telemetric data into a building information model presented as an augmented reality display or a virtual reality display to one or more users.

### SUMMARY OF THE INVENTION

The method and system generally creates an online augmented reality or virtual reality (AR-VR) product permitting the user, and multiple viewers, to interact with displayed components in a building information model (“BIM”) having data component tables. The method and system is not limited to an online, web-based platform but can be stored and operated in-house on a business-owned computer network. There are several embodiments of the invention including a realtime, telemetrics-based AR-VR platform; an AR-VR system wherein the user (and any viewers simultaneously interacting with the system) can concurrently view the as-is scan of the monitored facility, selected static data component tables, selected dynamic data component tables, and the then-current realtime V-BIM (the virtual BIM model) with all the then-acquired telemetric data captured on the monitored facility, and under user command and control, the static V-BIM (without integration of the realtime telemetric data); a method for integrating temporal data into a BIM based upon at least first and second temporal 3-D scans obtained over first and second disparate time frames of a temporally monitored facility; and an online system integrating substantially realtime telemeteric data into a BIM presented as an augmented reality display or a virtual reality display to one or more users.

In one embodiment, the method (and the system) substantially integrates realtime telemeteric data into a BIM which is then presented as an augmented reality display or a virtual reality display to one or more users. The method obtains one or more 3-D scans of a telemetrically monitored facility. Then the method spatially aligning a compatible BIM with the 3-D scan(s) and generates virtual reality BIM data (generally designated as V-BIM in this Summary) which V-BIM substantially spatially matches the monitored facility. As explained in the following Detailed Description of the Preferred Embodiments, the compatible BIM starts with the customer supplied design plan BIM or the as-built BIM, which is further processed by the steps discussed in detail below in the Description of the Preferred Embodiments.

The processed compatible BIM (V-BIM) has data representative of: (a) at least one telemetric monitor associated with at least one process occurring in the monitored facility (there are many monitors or process indicators on the facility and typically many ongoing processes on the facility), and (b) at least two static components associated with the identified process on the monitored facility. As described later, this representative data is found in static component data tables and dynamic component data tables. The method obtains dynamic component data representative of changeable data (for example, a maintenance schedule and the last maintenance event data (action plus date) and the future maintenance event data) and/or telemeteric monitor status and representative of at least one controlled variable in the facility's process. The obtained static component data is representative of at least two static components in the facility. As an example, the process monitor indicator may be a meter detecting flow and one static component may be a pipe handling slurry or fluid passing through both the flow meter and the pipe (upstream or downstream) and the second static component may be a valve effecting flow through the pipe. The dynamic component data and the static component data is linked to the virtual reality BIM data. For example, the link may be a computer data object permitting the user to visually select and point to a display of the component under study and concurrently the system displays the static component data table or dynamic component data table. The system displays the V-BIM and one or both of the dynamic component data or the static component data upon a user's command.

Further enhancements on the system and method include (a) generating the compatible BIM from a library of BIM data objects wherein the static components are included in the library of BIM data objects; and (b) wherein the dynamic component data represents a dynamic data object for one or both of the two static components; and (c) including data objects from as-built plans of the monitored facility. The generate the initial compatible BIM or to confirm the V-BIM prior to placing the V-BIM in dynamic operation, the system uses a piping/processing and instrumentation diagram (“P&ID”) for the monitored facility. The P&ID represents static component data, instrumentation component data and control component data. The P&ID also includes dynamic component data wherein the dynamic component data shows process flow data in the monitored facility, instrumentation status data in the monitored facility and control status data in the monitored facility. The control component data in the P&ID effects the process flow data at the facility.

The as-is 3-D scan data is the primary source electronic document for the method and the system. This as-is scan data can be displayed to the user upon command at many different times in order to confirm that the V-BIM does accurately spatially match the monitored facility. In a further enhanced version of the method and the system, a “first” static component is a pipe used in the process and this static component is designated as pipe static component data. The as-is scan data includes scan data representative of insulation over the pipe and further includes scan data representative of a flange on the pipe. The method calculates, from the 3-D as-is scan data the thickness of the flange. Common pipe design establishes that (a) the thickness of the flange matches the wall thickness of the pipe and (b) the wall thickness of the pipe further indicates the inner and outer diameter of the pipe. The system therefore estimates inside and outer diameters of the pipe based upon the flange thickness data. In the then-pre-processed virtual reality BIM data, the system uses a pipe BiM object data to represent the pipe. The V-BIM is then updated or changed to delete the insulation and replace the same with the pipe BIM object data. Different versions of the V-BIM are stored in the system such that the user can, upon command, see the V-BIM with the insulated pipes (this view helpful during renovation or maintenance in order to determine spatial clearances on the facility deck or floor) and the V-BIM without the insulation (more aggressively showing the actual process elements and static elements in play in the facility. Further, the pipe static component data is updated with the estimated outside and inside diameter data. A link is provided to the dynamic component data and the pipe static component data for the process under study.

The dynamic component data tables may include key performance indicator data tables for the monitored facility.

In another, somewhat more simplified embodiment of the invention wherein telemetric data is not integrated with the AR-VR V-BIM, the system obtains the 3-D scans as as-is data, obtains a compatible BIM having static component data matching static components visually represented in the as-is data, and having dynamic component data matching dynamic component data representative of one of the many processes occurring on or in the monitored facility. The system spatially aligns the compatible BIM with the as-is data to generate V-BIM data which substantially spatially matches the monitored facility. For each discrete static component data, a discrete static object link permits a respective display of the discrete static component data when the static object link is activated in the compatible BIM (the then-processed V-BIM). The compatible BIM has, for the dynamic component data, a dynamic object link permitting display of the dynamic component data when the dynamic object link is activated in the compatible BIM (V-BIM). The system and the method permits the user to concurrently display, in an AR-VR format, the virtual reality BIM data (V-BIM) which includes the compatible BIM data, the dynamic component data and the static component data. One or both of the dynamic component data and the static component data can be concurrently displayed with the V-BIM upon a user's command and also the user may display as-is data (the scan data) with or without a concurrent display of the V-BIM, thereby permitting views of (i) the as-is data: (ii) the V-BIM data; (iii) the discrete static component data, and (iv) the dynamic component data for the one process in the monitored facility.

In an additional embodiment, the 3-D scans of the facility are taken over at least two disparate time frames. This embodiment is best understood in connection with an archeological heritage site (generally referred to as a “heritage site”) wherein two 3-D scans are taken at different times with a reasonable intermediate time frame between each scan. During this intermediate time frame, additional portions of the heritage are exposed by persons on the site. However, there may be instances when temporally taken scan data is useful in connection with industrial plant facilities, industrial processing platforms, commercial sites, floating production storage and offloading vessels, and maritime vessels.

The system and method spatially aligns a first compatible BIM with the first temporal 3-D scan based upon at least primary and secondary static components found in both the first temporal 3-D scan and the first compatible BIM. In a heritage site, the primary and secondary static components may be edge points on opposite sides of a partially uncovered wall. The system generates a first virtual reality BIM data which substantially spatially matches the monitored facility at the first disparate time frame with a best fit algorithm and the primary and secondary static components. The system then spatially aligns a second compatible BIM with the second temporal 3-D scan to generate a second V-BIM which substantially spatially matches the monitored facility at the second disparate time frame and substantially spatially matches the first compatible BIM. The second compatible BIM has data representative of at least a tertiary static component associated with the monitored facility at the second disparate time frame. As an example, tertiary or third static component may be a corner edge of a corner stone in the wall then-partially uncovered at the heritage site. The system and method generates dynamic component data based upon the primary, secondary and tertiary static component data wherein the dynamic component data is an estimation of a fully functional BIM for the monitored facility. As an example, the fully functional V-BIM may project, based upon these three static components (the two opposing wall edge data points and the corner stone edge point) an estimated, but then-currently uncovered wall segment in the heritage site. The system links the dynamic component data and the primary, secondary and tertiary static component data with the second V-BIM data. Finally, the system displays on an AR-VR platform, the first V-BIM, the second V-BIM, the dynamic component data, and the static component data, all under command of the user.

The online system (typically a cloud based AR-VR platform), in accordance with the principles of the present invention includes a first online memory store for point cloud data representing the 3-D scan data of the telemetric monitored facility and a second memory store for the compatible BIM. The compatible BIM has a plurality of static component data tables, each static component data table matching a respective static component in the compatible BIM and visually represented in the 3-D scan data. The compatible BIM further has a plurality of dynamic component data tables wherein each dynamic component data table matches a respective process in a plurality of processes occurring on or in the monitored facility. One dynamic component data table has process telemetric data associated with the respective process. The resulting dynamic component data table is a telemetric dynamic component data table. The system has a process for spatially aligning the compatible BIM with the 3-D scan data to generate V-BIM (virtual reality BIM) data which substantially spatially matches the 3-D scan data. For example, the spatially alignment may use image recognition to identify components in the 3-D scan data, initially tag images as, for example, a valve, a meter, a pipe, a pipe flange, may then compute the distance between initially tagged images to determine distance, then alter the initial BIM (as supplied by the customer, or as-built, or as confirmed by the P&ID), may use color to match the tagged image with elements from a BIM library, may use thermal scan data to distinguish between hot and cold pipes and flanges, and may use other data elements which are found in the BIM library for a particular component.

The static component data tables and the dynamic component data tables have respective data object links associated with corresponding static and dynamic components represented in the 3-D scan data. In this manner, upon display of the V-BIM data and user activation of a visual representation of the corresponding data object link for the static or dynamic component, the respective data object link causes concurrent display of the corresponding static or dynamic component table and, upon further display of the V-BIM and further user activation of the displayed dynamic component associated with the telemetric dynamic component data table, the respective data object link causes concurrent display of the corresponding telemetric dynamic component table. Additional features include a measurement module that permits the user to virtually measure two or more points in the as-is scan and then apply that measurement to the V-BIM thereby spatially matching the V-BIM to the physical monitored facility (FAC). The V-BIM can also be overlaid with animation to show dynamic, changing conditions of resources and movable physical items in the monitored FAC. Additionally, the method and system can include a Data Import (“DI”) function which accepts data from mobile sensors or detectors at the monitored facility or FAC.

### BRIEF DESCRIPTION OF THE DRAWINGS

Further objects and advantages of the present invention can be found in the detailed description of the preferred embodiments when taken conjunction with the accompanying drawings.

FIG. 1A diagrammatically illustrates a system and a processing diagram for the method and system of developing an augmented reality or virtual reality BIM model.

FIG. 1B diagrammatically illustrates the visualization scheme for the system and method.

FIGS. 2A through 2K diagrammatically show the general process flowchart in accordance with the principles of the present invention. The process flowchart is sequentially presented in FIGS. 2A through 2K.

FIG. 3 diagrammatically illustrates one example of a virtual BIM model in accordance with the principles of the present invention.

FIGS. 4A through 4C diagrammatically illustrate the extraction module flowchart. The process flowchart is sequentially presented in FIGS. 4A through 4E.

FIGS. 5A, 5B and SC diagrammatically illustrate the extraction process for an outer layer covering a component, such as an outer layer of insulation on a pipe.

FIGS. 6A to 6C diagrammatically illustrate a viewer and editor module as a process flowchart. The process flowchart is sequentially presented in FIGS. 6A through 6C.

FIGS. 7A and 7B diagrammatically illustrate a maintenance predictor and implementer module as a process flowchart. The process flowchart is sequentially presented in FIGS. 7A and 7B.

FIGS. 8A though 8C diagrammatically illustrate a maintenance predictor, replace and implement module process flowchart. The process flowchart is sequentially presented in FIGS. 8A through 8C.

FIGS. 9A to 9C diagrammatically illustrate a building repair module as a process flowchart. The process flowchart is sequentially presented in FIGS. 9A through 9C.

FIGS. 10A to 10C diagrammatically illustrate a heritage reconstruction module as a process flowchart. The process flowchart is sequentially presented in FIGS. 10A through 10C.

FIG. 11 diagrammatically illustrates a display showing the various as-is scan data, RIM virtual display, and displays for static and dynamic component tables.

FIGS. 12A and 12B diagrammatically illustrate a heritage site reconstruction process.

### DETAILED DESCRIPTION OF THE PREFERRED EMBODIMENTS

The present invention relates to a system and a method for converting 3-D as-is scan data into either an augmented or virtual reality presentation of a building information model (“BIM”) which spatially matches the 3-D as-is scan data. Various modules enable the user to integrate telemetric data into the AR or VR BIM display and presentation data or to integrate temporal data which is based upon 3-D scan data obtained at two disparate time frames. The telemetric data or changeable data is converted into dynamic component data and the user can view the dynamic data by activating a data object link on the visually presented component in the BIM virtual display. With respect to the temporal data, two compatible BIM models or plans are generated over two disparate time frames and these two BIM models are spatially aligned to create the virtual reality BIM data. The present invention handles AR and VR data for industrial plant facilities, industrial processing platforms, commercial sites, floating production storage and offloading vessels, maritime vessels in heritage archaeological sites. Herein these facilities and sites are generally identified as “monitored facilities”. Similar numerals designate similar items throughout the drawings. The present system and method can be used for many functions on a wide range of monitored facilities.

In the drawings, and sometimes in the specification, reference is made to certain abbreviations. An Abbreviations Table presented later herein provides a correspondence between the abbreviations and the item or feature.

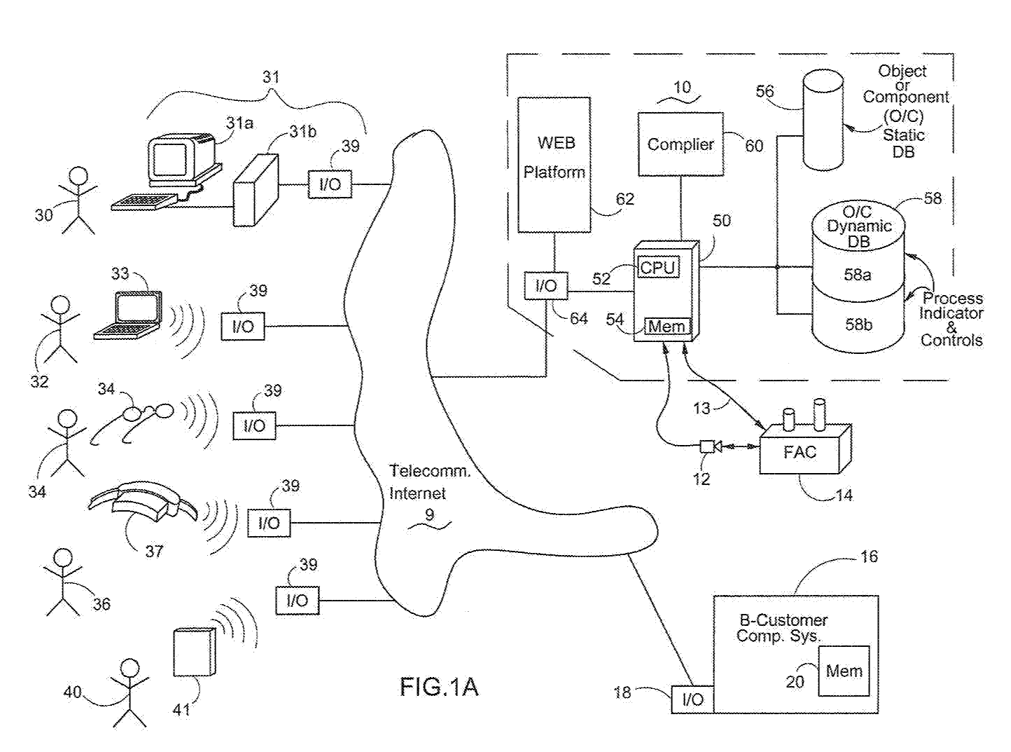

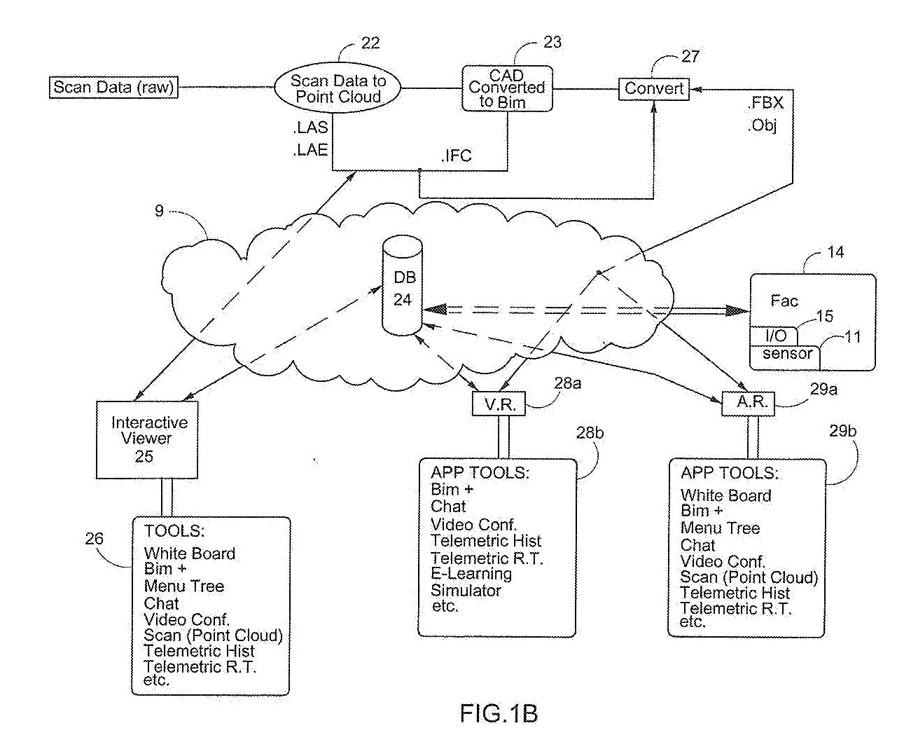

The virtual BIM (V-BIM) presentation generally combines Point Cloud data from the as-is scan and converts CAD models to BIM model data for the monitored facility. See FIG. 1B. This permits the user or users to (a) prepare route plans for the transfer, installation and removal of equipment (in less time and with greater precision) and to reduce transfer costs; (b) evaluate future modifications in equipment, structures and routes changes of pipelines; (c) prepare plans with high precision; and (d) update of As-built and P & ID's plans. The system and method can be configured to estimate deformation of facility components and structures and enable collision detection. The system generates BIM models associated with database and detailed information on, processes (fluids, pressure, temperature, etc.), characteristics of mechanical elements (type, materials, diameters, thicknesses, etc.) and maintenance management information, inspection dates, replacement dates, number of replacements. The system permits filtering of list of materials and information generation for major maintenance. The system also handles determination of energy loss (heat), hot spots (thermal insulation) and faults in rotating equipment. The system and method permits visualization of Point Cloud data as the as-is 3D scan, and CAD-BIM models all on a web platform viewable through a web browser.

The Viewer Module permits a user to access the CAD and BIM models through internet from any workstation or mobile device. It allows visualization and interaction of CAD and BIM models through virtual tours, decomposition of all the elements in the virtual BIM model. It allows for multiple users with access control. Real time chat features permit multiple online users to interact with the same virtual BIM model presentation. The system allows auditing of the file history and operations.

As for Augmented Reality, the system and method includes the following product features. A static view information-presentation from the virtual BIM or V-BIM display presentation or any other digital information of the plant in the augmented reality glasses—ARG (the point cloud as-is scan data is not going to be accessed). Plant monitoring can be provided to the ARG in real-time if it is automated. In case the monitoring is not automated, the process of automation of the monitoring is offered. Real-time interaction through video conference with a supervisor user in a remote location with the possibility of sharing, image, audio, voice and information in general. The system recognizes physical objects that have been previously fed to the database. The instrument does not hinder the vision of the real environment while it is being used. The system is able to use the user's position, orientation and scrolling path to select and filter the displayed information. The system is able to recognize QR codes. Interaction with virtual objects through audio recognition, gestures and accessory pointers is provided. The system permits instruction and automated training in the field. Remote viewing access of confined spaces is enabled.

The system and method, in connection with its virtual reality provisions, enable an immersive tour of the V-BIM and the point cloud as-is scan data with real-time information. A remote review of the facilities is permitted. The virtual reality module permits visualization, travel and interaction with virtual digital V-BIM models, both proposed V-BIM models or existing V-BIM models, for simulations or case analysis. Access to training rooms and visual virtual conferences is permitted. Real-time plant monitoring for automated systems and processes is also permitted. The user can engage in static travel or travel in controlled environments. The system is able to find the user's position, orientation and scrolling path to select and filter the displayed information. Interaction with objects of virtual reality, through pointers, accessories and voice recognition is enabled. Unlimited power is provided due to the wired connection with a high-capacity workstation. The system can be used as a guide system in a remote training system.

The industrial applications include design, construction, operation and decommissioning applications. Regarding design, the system can be engaged for (a) surveys of existing facilities for repairs, revamping or de-bottlenecking; (b) virtual walkthroughs; (c) high-precision measurements; (d) Clash or crash detection; (e) Tie In connections; (f) Route design for equipment mobilization; and (g) Optimal space distribution for equipment installation. In construction, the applications include (a) Work in progress follow up of construction process; (b) Immediate registry and blueprint of modifications; (c) Verification of tolerances and assembly procedures of parts or complete modules; (d) Improved Quality Assurance and Quality Control (QA/QC); and (e) As-Built documentation. In operations, the applications include: (a) Collaborative web based asset management; (b) Designing, planning and reporting of modifications; (c) Measuring and monitoring deformations of structures and components; (d) Predictive and preventing maintenance: scope of work, bill of materials, project status reports; (e) Asset management with visual tools for inventory control; (f) Registration of accidents (forensic engineering); and (g) Optimization of production lines. Regarding decommissioning, the applications include: (a) Decommissioning planning; and (b) Scope of work, label, bill of materials and transportation logistics.

With respect to vessel and yachts, the system can be used for (a) Laser scanning and creating a complete registry of all the mechanical, structural and design elements, generating as-built documentation to be used for modifications, maintenance and repairs; (b) Laser-scanning for surveying the vessel hull to conduct studies on its hydrodynamic behavior and possible improvements; (c) Digitizing the interior and exterior of the structure of the yacht during its construction for the subsequent design and coupling of the finishes; and (d) Digitizing internal areas of the vessel for asset control.

Regarding maritime applications, the system and method enables: (a) 3D Laser Scanning for Shipyards/Ports; (b) It reduces ship downtimes facilitating the detail and accuracy of the offer process; (c) Permits virtual walk-thru and engineering studies that speed evaluation, modifications, extensions and optimization of repair tasks; (d) Facilitates the prefabrication of pipes, measurement and prefabrication of structures deformations caused by collisions; (e) Facilitates the manufacture of complex structures without having to visit the ship; (f) Preparation of a 3D PLOT PLAN of all the shipyard facilities through which areas in use can be optimized, and new areas incorporated; (g) Engineering studies for the installation and/or replacement of equipment in engine rooms, pump rooms, main decks and other important areas of the ships; (f) 3D survey of the ship's hull for engineering studies to increase the overall efficiency of the ship; (g) 3D Laser Scanning Offshore Platforms, Special Ships and Maritime Sector in General; (h) Expedites projects for the manufacture of complex structures facilitating dimensional control with millimetric error margins; (i) Updates of AS-BUILT drawings for the redesign and transformation of on board installations without affecting operations; (j) Facilitates the prefabrication of pipes, measurement and prefabrication of structures deformations caused by collisions; (k) Thermographic registry and analysis for hot and cold cargoes for the study of energy deficiencies; (l) Thickness ultrasonic measurement; (m) Audiometric testing; (n) Applications able to integrate the software in use by the client with our BIM model, to facilitate the analysis and control of maintenance and asset management; and (o) Planning of dry dock projects.

Regarding oil and gas applications, the system and method enables design, construction, operation and decommissioning planning. In design, the system enables: (a) Surveys existing facilities for repairs, revamping or de-bottlenecking; (b) virtual walkthroughs; (c) high-precision measurements; (c) detects clash incidents and detection; (d) Tie-in connections; (e) Route design for equipment mobilization; and (f) Optimal space distribution for equipment installation. In construction, the system permits: (a) Work in progress follow up of construction process; (b) Immediate registry and blueprint of modifications; (c) Verification of tolerances and assembly procedures of parts or complete modules; (d) Improved Quality Assurance and Quality Control (QA/QC); and (e) As-Built documentation. In operations, the system and method enables: (a) Collaborative web based asset management in a graphic environment; (b) Designing, planning and reporting of modifications; (c) Measuring and monitoring deformations of structures and components; (d) Predictive and preventive maintenance: scope of work, bill of materials, project status reports; (e) Asset management with visual tools for inventory control; and (f) Registration of accidents (forensic engineering). Regarding decommissioning, the system permits: (a) Decommissioning planning; and (b) Scope of work, label, bill of materials and transportation logistics.

FIG. 1A diagrammatically illustrates a system and a processing diagram for the method and system of developing an augmented reality or virtual reality V-BIM model presentation. FIG. 1B diagrammatically illustrates the visualization scheme for the system and method. Both FIGS. 1A and 1B are discussed concurrently herein. Typically, the system and method would be provided by a central operations unit 10 which is coupled via input/output device 64 to a telecommunication network, commonly called Internet 9. However, the system and method could be deployed completely within business customer computer system 16. Also in operation, various users 30, 32, 34, 36 and 40 are provided access to the augmented reality or virtual reality, the V-BIM data presentation on one or more Internet enabled devices. These Internet enabled devices are diagrammatically illustrated in FIG. 1A as, for example, computer system 31 associated with user 30, which includes monitor and keyboard 31A, central processing unit or desktop computer 31B and input/output device or router 39. Router 39 is connected to Internet 9.

User 32 may view the V-BIM data presentation on laptop 33 which is in a wireless communication mode with input/output device 39. User 34 may view the augmented reality or virtual reality V-BIM presentation via eye glasses or goggles 35. These goggles are also connected to an input/output device 39 and ultimately connected to Internet 9. User 36 may employ VR headgear 37 for a virtual reality display of the V-BIM data presentation. This V-BIM data presentation is supplied via input/output device 39 and Internet 9. User 40 employees a computer tablet 41 wirelessly connected to input/output device 39.

FIG. 1B shows that the system gathers raw 3-D scan data in operational-informational block 22 and this scan data is converted into the point cloud data in block 22. Currently, the point cloud data is classified as “.LAS” data or “.LAE” data. CAD data (as described later herein as compatible BIM data) is converted to virtual BIM data models in block 23. The processed V-BIM data is classified as “.IFC” data. This point cloud (or as explained later, the as-is scan data) and the V-BIM data sent made available to an interactive viewer 25 via Internet telecom system 9. Further, the V-BIM data is integrated or merged with the component data (explained later) located in database 24 (which represents memory and databases 54, 56, 58, 58a, 58b). The interactive viewer 55 permits the user, and any authorized viewer, to manipulate the presented as-is scan (point cloud) data and/or the presented processed V-BIM data with tools as indicated in Tool Box 26.

Regarding virtual reality headset 28a and augmented reality display system 29a, these user-viewer display systems are fed point cloud data and processed V-BIM data in the data format “.FBX“and”.Obj”. Component data form database 24 supplements the as-is (point cloud) data and V-BIM data on the VR or AR displays 28a, 29a. In the V.R. environment, the user-viewer has access to tools, shown in Tool Box 28b. The A.R. user-viewer has access to tools in Tool Box 29b. It should be noted that other tools may be made available to the user-viewer.

The central operations unit 10 generally includes a server computer 50 with a central processing unit 52 and various types of memory 54. Point cloud data from the as-is scan data is stored in memory 54 in the central operating unit 10. Server computer 50 is coupled to input/output device 64. A web platform 62 may also be utilized either as part of computer server 54 (as a web platform module) or as an independent processing module. The web platform interacts with users 30, 32, 34, 36 and 40 as needed. Computer server 50 also includes a compiler module 60 (which may be a module in the server 50 or an independent unit or module) which compiles information from the as-is 3D scan data (the as-is scan data stored in memory 54) and the object component data from databases 58, 58A, 58B and 56. Database 56 is an object or component static database. Database 58 is an object or component dynamic database. Database segment 58A is a process indicator database (indicators such as meters, temperatures sensors, etc.) and database segment 58B is a controller database (control units such as control valves, burners, coolers, etc.). The dynamic component database can also include any changeable data related to the “static” aspects of the component being modeled in the V-BIM. For example, the dynamic nature of maintenance and replacement of a component is changeable over time. Most components have life cycle data and maintenance data. This changeable data type is stored in the dynamic component database. These databases may be part of memory 54, however for purposes of explanation herein, the databases are illustrated as separate memory units. In practice, a single memory store is employed with segmented devoted to the functions and data storage facilities described herein.

In operation, process indicator data and controller data is exchanged on telecommunications line 30 between facility 14 and the central operations unit 10. In some situations, scanner or image camera 12 can be employed in facility 14 and provide substantially realtime image data to central operations unit 10. Line 30 may be directed into Internet 9.

In order to initialize the present system, a 3-D image scanner is deployed at a predetermined geographic location at facility 14 and a 3-D scan is taken of the facility, the facility floor or facility deck. The resulting image data is the as-is scan data. Also in the initialization or set up routine, a business customer operating business customer computer system 16 has, in its memory 20, the building information model either from the original plans for facility 14 or as modified as markup building information model data. This as-build BIM data is sent through input/output module 18 via Internet 9 to the central operating unit 10. More details of this set up are discussed in connection with the flow charts.

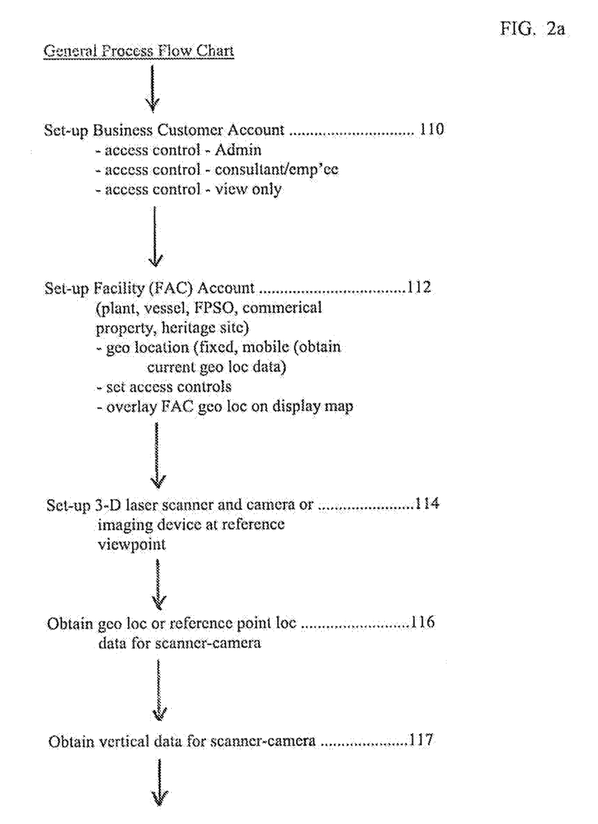

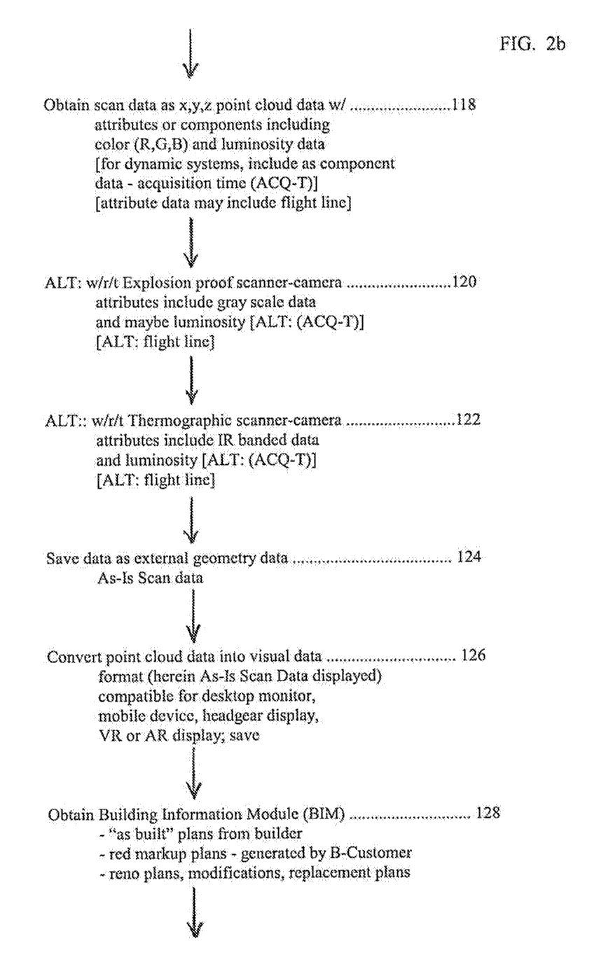

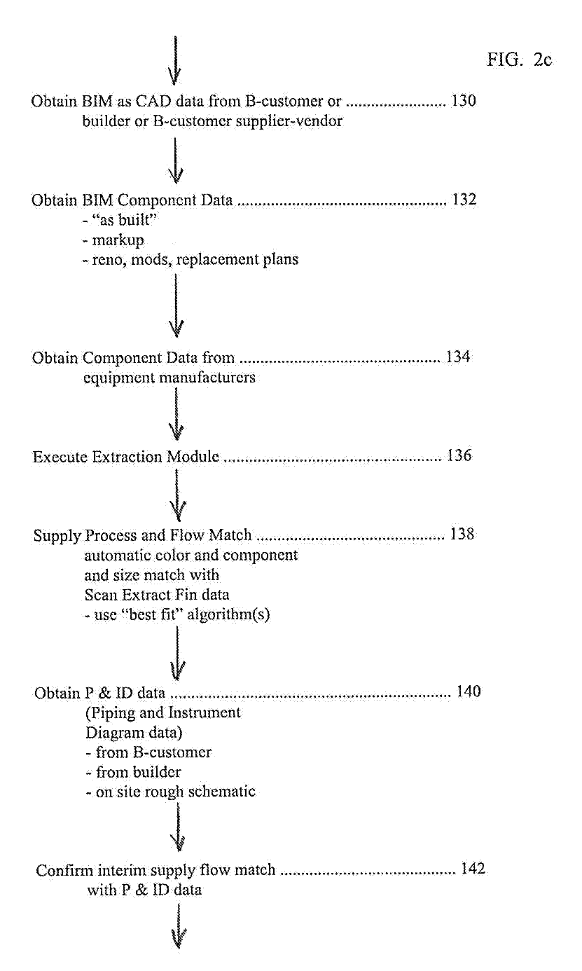

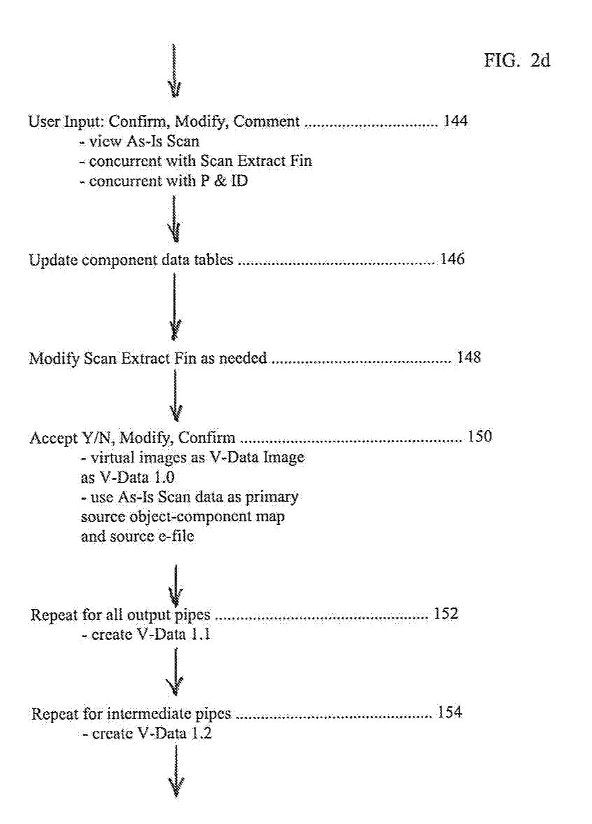

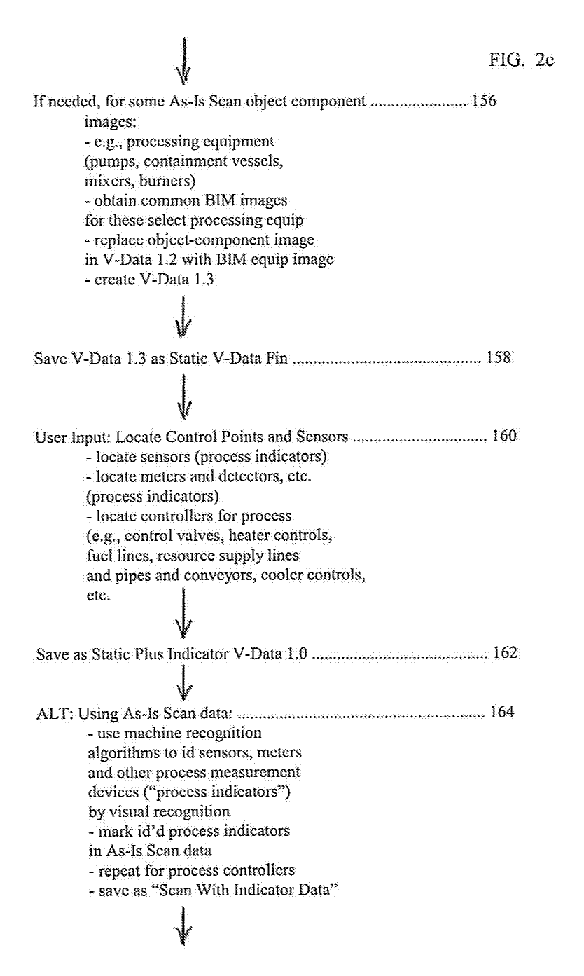

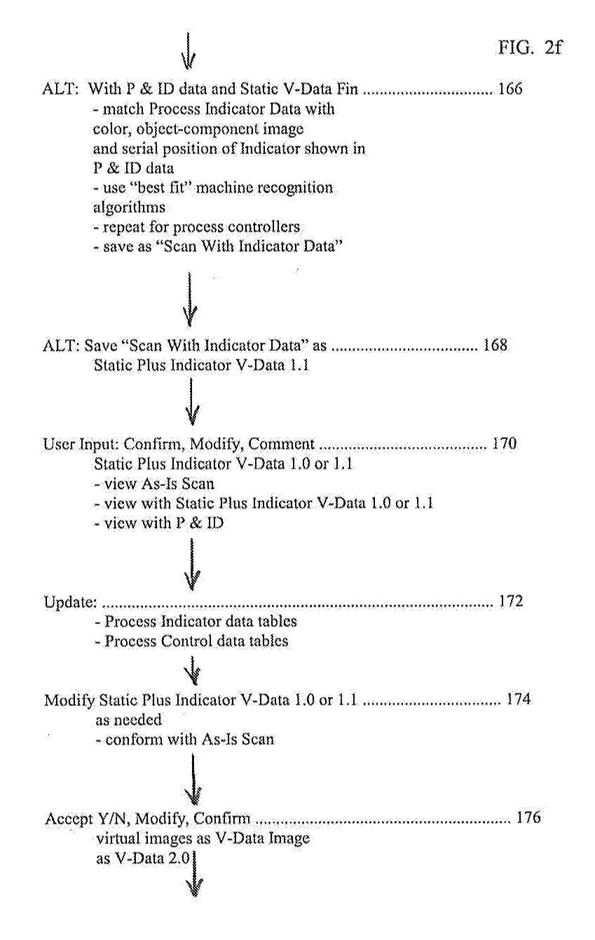

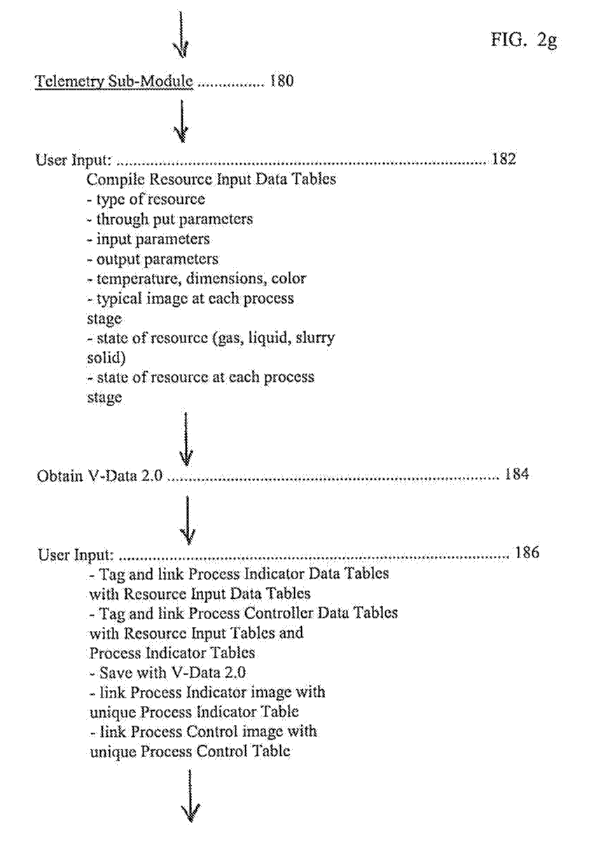

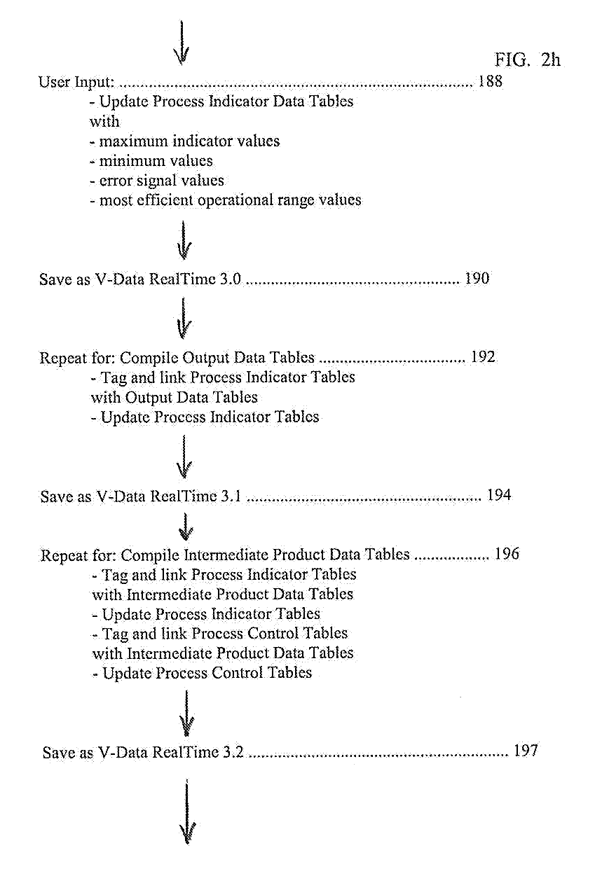

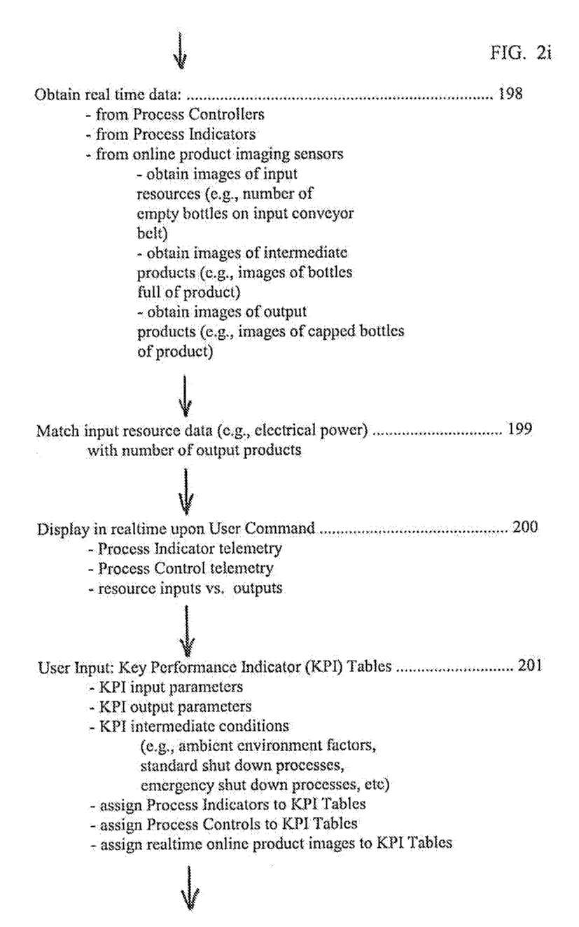

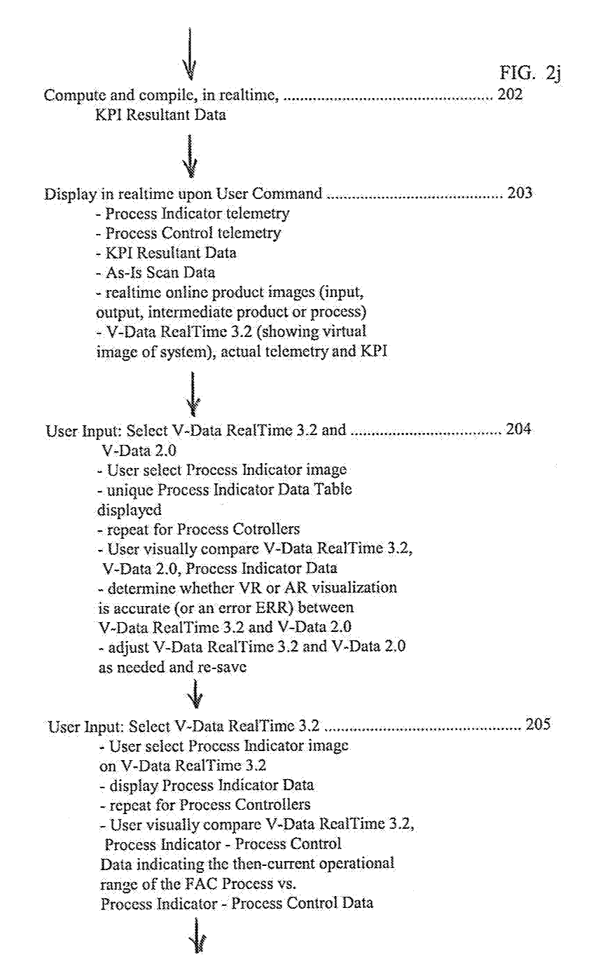

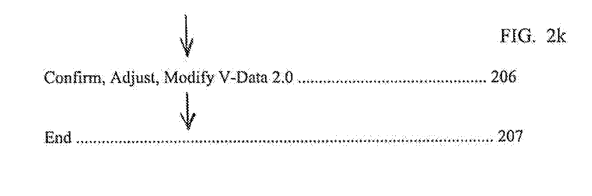

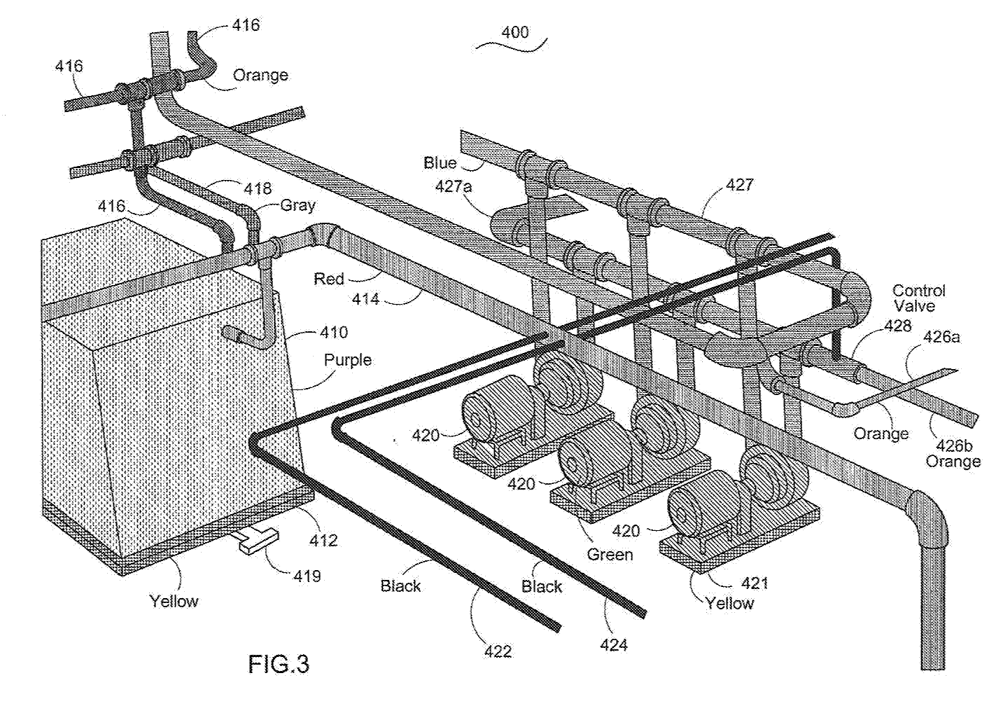

Before discussing FIGS. 2A through 2K, which diagrammatically show the general process flowchart in accordance with the principles of the present invention (sequentially presented), a discussion of the V-BIM presentation in FIG. 3 is useful. FIG. 3 diagrammatically illustrates one example of a virtual BIM model (V-BIM data presentation) in accordance with the principles of the present invention.

FIG. 3 is a simplified small version of a color-coded V-BIM data display. In this V-BIM data display, boiler 410, shown in purple shading, is fed from supply line 416 (shaded orange) and second supply line 418 (shown in gray). Boiler 410 is mounted on a platform 412 (shaded yellow) and has a relief valve 419. The output from boiler 410 is delivered to hot output pipes 414 (shaded red).

A series of pumps 420 (shaded green) are mounted on platforms 421 (shaded yellow). Pumps 420 are supplied with fluid or slurry via supply pipes 427 (shaded blue) and 426a (orange) and the output from pumps 420 on pipe lines 427a (blue) ultimately leads to output line 426b (shaded orange). One of the control valves 428 is shown at an intermediate location on output line 426b. Another control valve (not numbered) for pump 420 is connected to pipe 426b. Boiler 410 has a burner control to regulate the temperature in boiler 410 (the controller is not shown in FIG. 3). Also, boiler 410 has one or more temperature sensors (process indicators) which are not shown in FIG. 3. These control signals and process indicator signals are applied to wires or fiber optic cables running in control pipes 422, 424 (shaded black). Control pipe 424 leads to control valve 428.

FIGS. 2A through 2K diagrammatically show the general process flowchart in accordance with the principles of the present invention. The process flowchart is sequentially presented in FIGS. 2A through 2K. Although all the flowcharts herein show processes in sequential order, persons of ordinary skill in the art may reorganize the steps, add additional steps and otherwise change the manner and mode of executing the steps described in these various flowcharts.

The business customer account is set up in step 110. In addition to the customary data, name, address, email, access control and data control is established by assigning profiles to administrators, consultants or employees who can add, edit or change data and establish other access control permitting “view” only of the V-BIM and as-scanned data. See FIG. 11. In step 112, the facility account is established. This account identifies the monitored facility, that is, the industrial plant facility, the industrial processing platform, commercial site, floating production storage and offloading vessel, maritime vessel or heritage archaeological site. The geolocation of the monitored facility is identified along with information as to whether the facility is in a fixed location or is mobile, is typical with marine vessels and sometimes with floating production vessels. Access controls are also set for the monitored facility and an overlay of the geographic location of the monitored facility is provided on a regional or world map displayed to the user-viewer. In this manner, when a user-viewer is initially provided access to the V-BIM system, a regional map is displayed or presented to the user-viewer (see FIG. 1A, web platform module 62 and users 30, 32, 34, 36 and 40) thereby permitting the user-viewer to select one of many monitored facilities operated by the business customer by point-and-clicking on the map. Alternatively, after the sign-on screen and access verification control function, the initial presentation screen may list, in a table, the project name, a project type description (new design, renovation, maintenance) and access to different versions of the V-BIM (chronologic order or by alpha-numeric order). Further the user may select a video library of past engineering sessions involving various V-BIMs. A web conferencing tool may also be provided permitting the viewers and user to select different V-BIMs for different monitored facilities and to display, concurrently, these two different V-BIMS. For example, similar processing vessels may have decks which process the same materials. By comparing the V-BIM from one vessel deck to a second vessel deck, the business customer can standardize P&ID, color, processing times, maintenance, etc. The white board function can be accessed via any type of telecom session, voice, video, or interactive text.

Step 114 initializes the system. A 3-D laser scanner and imaging camera is set at a certain reference viewpoint on the monitored facility and, specifically, on the floor or deck of the facility. Scanner-camera imaging systems made Zoller-Frohlich of Germany and can be used to capture the As-Is data discussed herein. In step 116, a geolocation or reference point location is obtained for the image scanner-camera. In step 117, vertical data is established for the scanner-camera. In step 118, the imaging device obtains as-is scan data as an X, Y, Z point cloud data with attributes or data components including color (red, green, blue) in luminosity data. Additionally, for certain dynamic systems, the component data may include an acquisition time and other component supplemental data, such as flight time data. In step 120, as an alternative or an optional step, an explosion proof scanner-camera imaging device may be utilized. The explosion proof camera generates grayscale data and possibly luminosity of the scanned and laser marked image. Alternatively, acquisition time and flight time may be included in this scanned data. In another alternative step 122, a thermographic scanner-camera and imaging device may be utilized. The thermographic imaging device obtains infrared data in luminosity data. Time data and flight time data may be supplemental data components acquired by the imaging device.

In step 124, this scanned data is saved or stored both in the memory of the imaging device and ultimately is uploaded to memory 54 in the central operating unit 10 of FIG. 1A. The data is identified in this patent specification as as-is scan data. In step 128, the last available building information module (BIM) is obtained either from the business customer computer system 116, stored in memory 20 (FIG. 1A), or from a contractor associated with the business customer. This original or initial BIM data may be “as built” plans from the builder or party contracted to construct the monitored facility, a red markup plan typically generated by the business customer (or alternatively by the building contractor) or may include renovation plans, modifications and any replacement plans saved by the business customer. Typically, this information would be uploaded through the Internet to central operating unit 10. Alternatively, the initial BIM data may be supplied by memory stick, removable hard drive or other portable memory devices to the central operating unit 10. Step 130 recognizes that the original or initial BIM data may be computer aided design CAD data from the business customer or the builder of the monitored facility or the business customer's supplier-vendor.

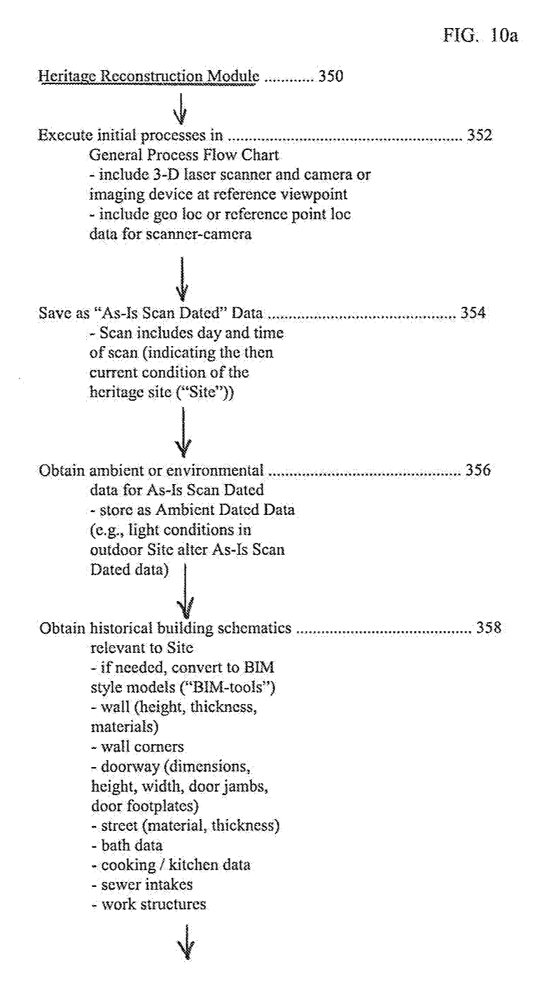

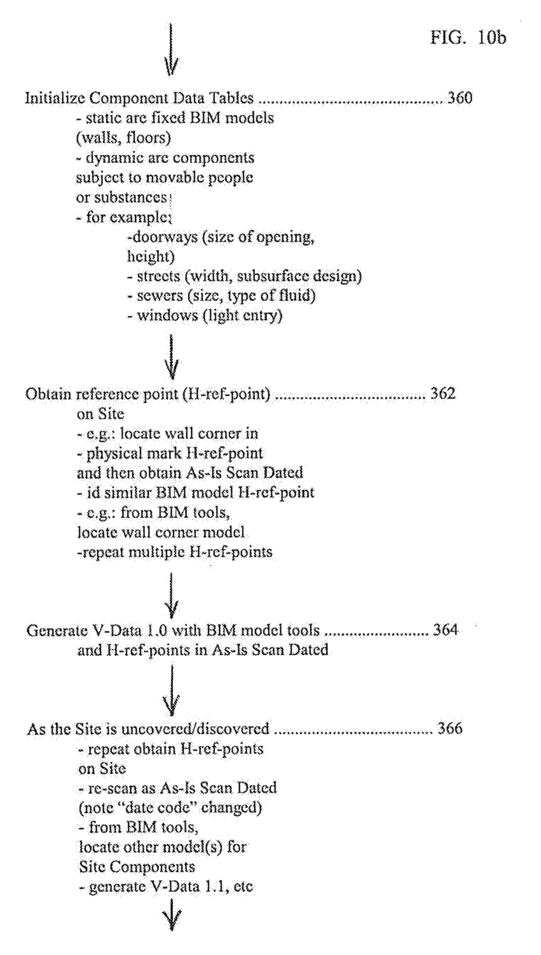

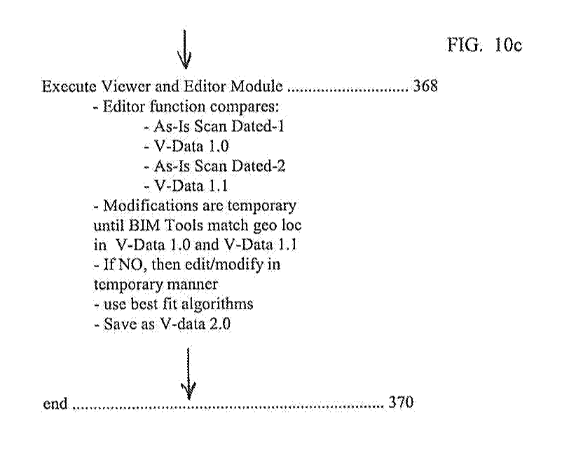

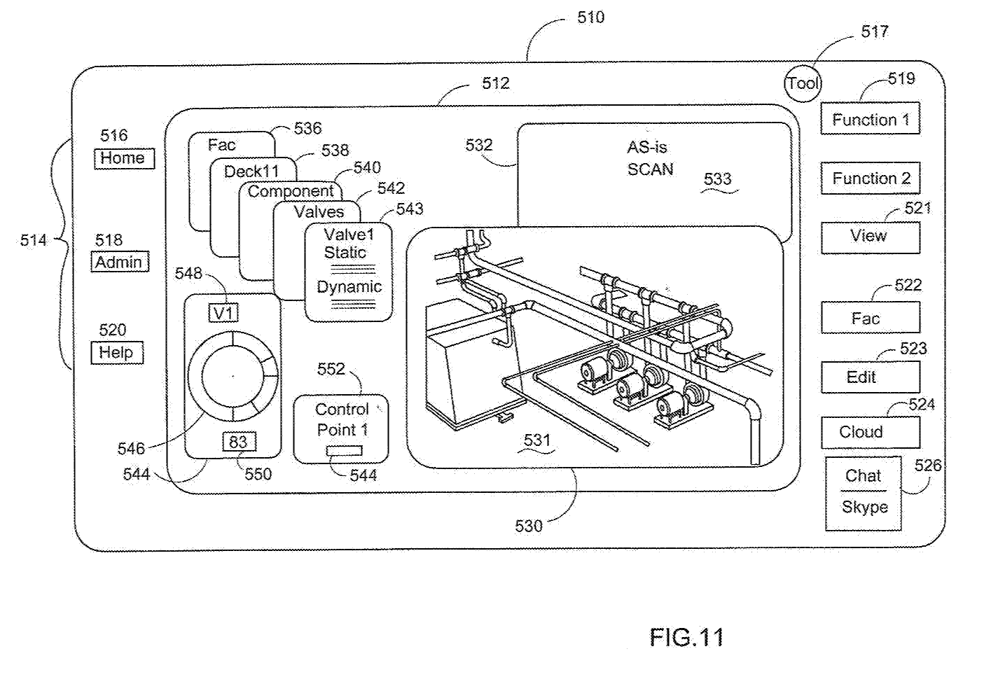

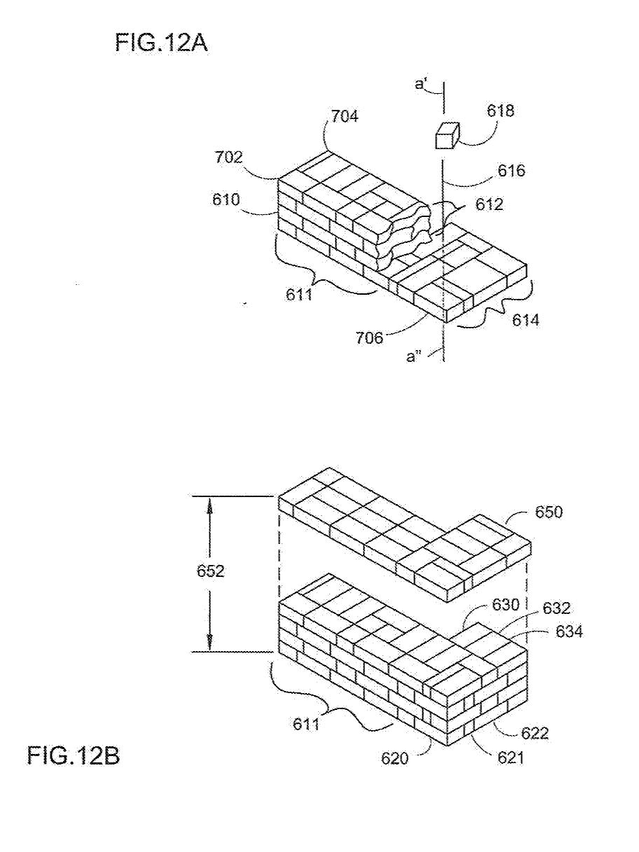

Regarding selection of a building information module (BIM) at the beginning of the process, reference is sometimes made herein to use a “compatible BIM.” The starting BIM (in digital form) can be (a) from the business owner's original building plans; (b) from original CAD-CAM plans; (c) from original plans marked up as “as-built” BIM plans (the same is true of CAD data); and (d) from earlier BIM designed renovations. If some components in the as-is scan are not in this initially available BIM data (for example a new style oven and enclosed burner/heater), then the manufacturer may have a BIM model for that equipment. Also, BIM model data may be available from trade groups and educational institutions. In general, these initial sources of BIM data for the monitored facility are sometimes called herein “BIM tools” because these data representations (the display and any associated component data table) are a tool used by designers to prepare BIM presentations for their customers. BIM model data from trade groups and educational institutions may be grouped into a library of BIM data objects. Industrial designers use the library of BIM data objects to design facilities. Since these variable sources of initial BIM data are difficult to identify, a “compatible BIM” as used herein refers to the set of initial BIM data discussed herein and any other BIM tools that are readily available to designers. In connection with BIM tools and the heritage archeological BIM virtual modeling discussed in FIGS. 10A and 12A and 12B, the initial set of compatible BIM tools may be earlier digital models of other heritage sites. As discussed later, the initial BIM data is spatially mapped to the as-is scan data and then refined such that the resultant BIM data spatially matches and agrees with the as-is scan data. See matching steps in the General Process Flow chart of FIGS. 2A through 2K. As more fully explored in the discussion of the flowcharts herein, a fully functional BIM not only spatially maps to the facility plant floor or vessel deck, but the fully functional BIM is the operable virtual BIM discussed later (sometimes referred to as V-data 2.0 (step 176, FIG. 2F) or V-Data RealTime 3.2 (step 204, FIG. 2J). Further regarding the initial BIM data, the invention describes the use and integration of P&ID schematics which are piping and instrumentation drawings or documents, sometimes more broadly identified as processing and instrumentation documents. P&ID data shows in detailed for the operational flow of material and the processing steps for the monitored facility. P&ID data supplements the initial BIM data and is used to confirm the virtual BIM data created as the operational element in the inventive system and method.

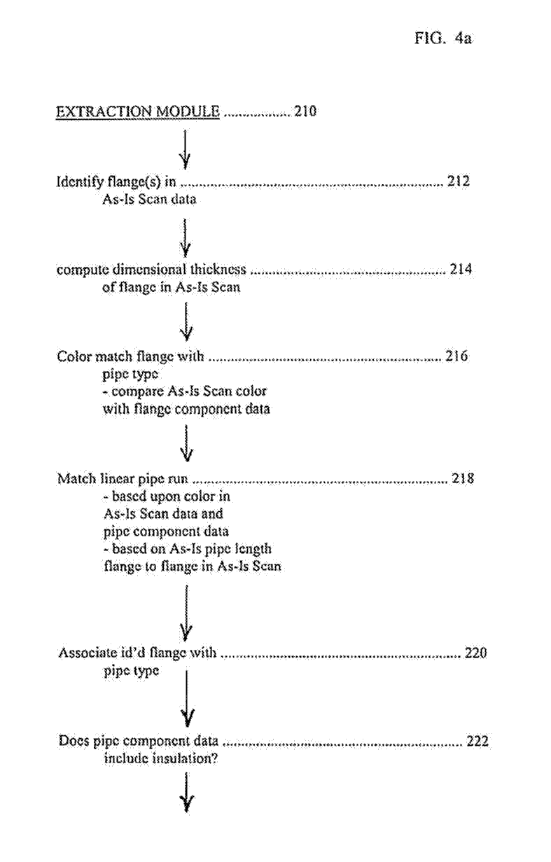

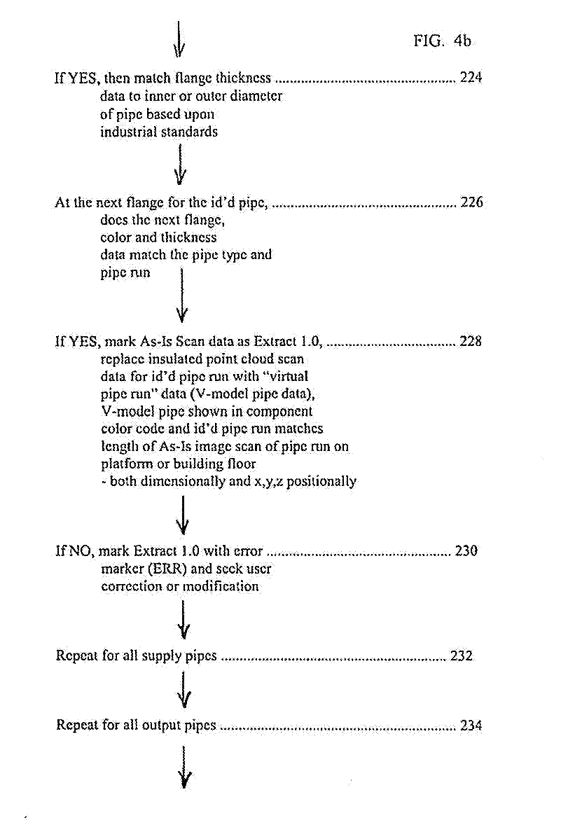

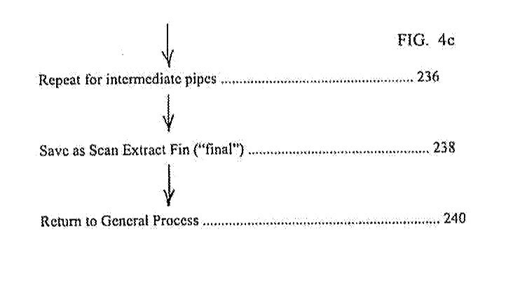

In step 132, component data for the various items in the originally supplied BIM data are identified. For example, with respect to FIG. 3, examples of BIM component data obtained from the business customer or its vendor/builder may be data regarding boiler 410, the type of pumps 420, the control signals on wires or fiber optics carried by covered control lines 422, 424, and certain data regarding output pipes 414, input supply pipes 418, 416, and operations of and specifications for control valve 428. Sometimes the business customer will not have all the component data for particular components on the monitored facility. Therefore, in step 134, component data from equipment manufacturers is obtained. In step 132, the component data is further obtained as provided for in the “as built” initial BIM data, in markup BIM data and in further in renovation, modification and replacement plan data. Step 136 in FIG. 2C executes the Extraction Module set forth in flowcharts at FIGS. 4A through 4E.

Examples of component data are shown below.

BIM Component Data Table

```
supply valve size a, b, c
supply pipes, size a, b, c
      supply flows 1, 2, 3
supply insulation Y/N/color
supply tanks, size a, b, c
intermediate process tanks a, b, c
output valve size a, b, c
output pipes, size a, b, c
      output flows 1, 2, 3
output insulation Y/N/color
pumps a, b, c
valves:
      relief, flow control
      bypass, flow restrictors
mixers
beaters
coolers
burners
etc.
```

BIM Component Color Data Table

```
supply valve size a, b, c
      color flange matches flow type
      controls gray
supply pipes, size a, b, c
      supply flows 1, 2, 3
      hot flow = dark red
      medium temp flow = medium red
      ambient temp = bold pink
      cool flow = mild pink
supply insulation = white
supply tanks, size a, b, c
      dark blue
intermediate process tanks a, b, c
      medium blue color
output valve size a, b, c
      color flange matches flow type
      controls white
output pipes, size a, b, c
      output flows 1, 2, 3
      hot flow = bold orange
      medium temp flow = light orange
      ambient temp = bold pink
      cool flow = peach
output insulation = light gray
pumps a, b, c
      all forest green
valves
      relief (all bright green),
etc.
```

Scan “As Is” Component Data Table

Pantone gray band =

supply valve size a, b, c, gray

Pantone red bands, r1, r2, r3, r4 =

supply pipes, size a, b, c
supply flows 1, 2, 3
r1 = hot flow = dark red
r2 = medium temp flow = medium red
r3= ambient temp = bold pink
r4 = cool flow = mild pink

Pantone blue band, b1 =

supply tanks, size a, b, c, dark blue

Pantone blue band, b2 =

intermediate process tanks a, b, c, med. blue

Pantone white band, w1 =

output valve size a, b, c, white

Pantone orange bands, o1, etc. =

output pipes, size a, b, c
output flows 1, 2, 3
o1 = hot flow = bold orange
o2 = med temp flow = light orange
o3 = ambient temp = med. pink
o4 = cool flow = peach

Pantone dark green bands =

pumps a, b, c - forest green

Pantone bright green bands =

valves:
relief (all bright green),
flow control
bypass, flow restrictors

The examples of these component data tables above sometimes include color data for the component. If the monitored facility follows a common color scheme for identifying physical components on the plant floor or deck, that is, equipment, piping, process indicators (meters, sensors, etc.), and process controllers (adjustable valves, heater/burner controls, etc.), and the initial BIM data has the same or similar color scheme, the resulting initial component data for those physical components and equipment can be used to (a) auto-populate the component data tables and (b) automatically color match the physical components and equipment from the as-is scan data to the initial BIM data. For these reasons, some component data tables above refer to Scan “As Is” Component Data Table. Additionally, or in the alternative, if the monitored facility follows a common color scheme for identifying physical components and equipment, this color scheme data can be used to (a) complete the “As Is” Component Data Table with an auto-populate routine and (b) used to initially spatially map the As-Is scan data to the initial compatible BIM data. To some degree, the process of matching, in a spatial manner the initial compatible BIM to the as-is scan data is an iterative process. Color matching and image matching techniques are used. For certain monitored facilities (for example, explosion prone facilities or thermally aggressive facilities), the scanner-imaging camera captures IR data, bit not color data. The component data table and the as-is data table would use IR or thermal band matching techniques to differentiate physical components and equipment on the facility floor or deck. This matching process uses best fit computer algorithms, image recognition, and generation of component data tables. Given the wide application of the present invention to a variety of monitored facilities and the variety of the initial BIM data and component data, it is difficult to specify the best method to spatially map the initial BIM data to the as-is scan data. As discussed later herein, the as-is scan data is the primary source electronic document and is used as a reference at many operational stages of the present invention. Further, the advancement of image recognition computer software reduces the operator's interaction with the system and method of the present invention.

Additionally with respect to the component data tables, computer software design concepts relating to database data object and data objects in general are applicable to the present invention. Generally, a database object in a relational database is a data structure used to either store or reference data and herein reference to a “table” encompasses those design concepts. These tables may include indexes, stored procedures, sequences, views and other software tools. In a similar manner, the tables herein represent data objects. In general, data objects are regions of storage that contain a value or group of values, wherein each value can be accessed using its identifier or a more complex expression. Herein reference to a “table” encompasses the software design concept of a data object. For example, a discrete static object link may become operable when the user places the cursor over display of the equipment such that the associated data table is displayed to the user and viewers. The initial compatible BIM data may include static data objects and dynamic data objects which can be used to initially populate the component tables described herein. Further as described later, these data tables have links active in the virtual BIM data display which call up the data tables as needed by the user or operator. The distinction between static component tables and dynamic component tables is better explained later in connection with, among other things, the Telemetry Module at FIG. 2G. The overlap of some data points in a static component data table and a dynamic data table reflects that, in a static state, the equipment does not change, but as material is processed by the facility, there are dynamic conditions associated with the equipment under consideration. Dynamic data further includes maintenance schedules and life cycle data for the component.

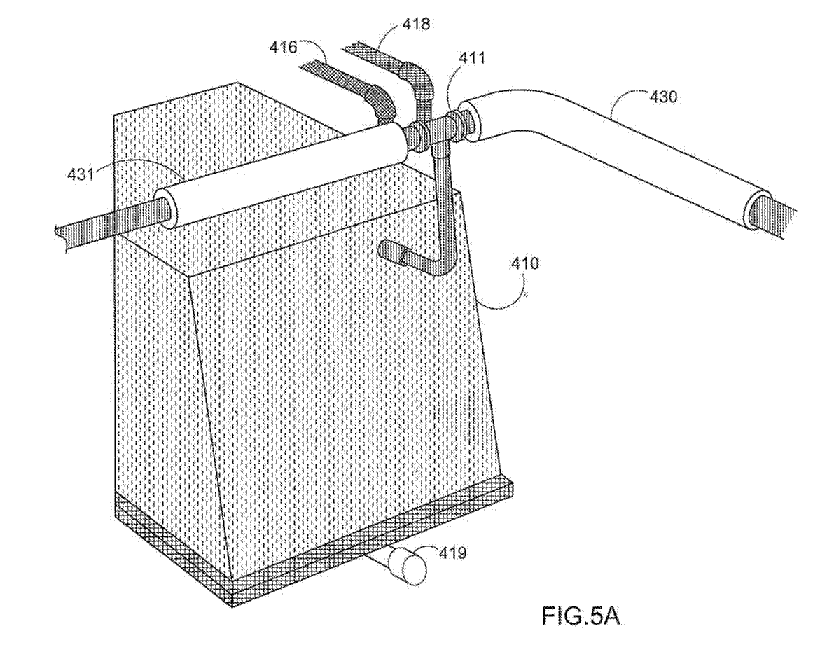

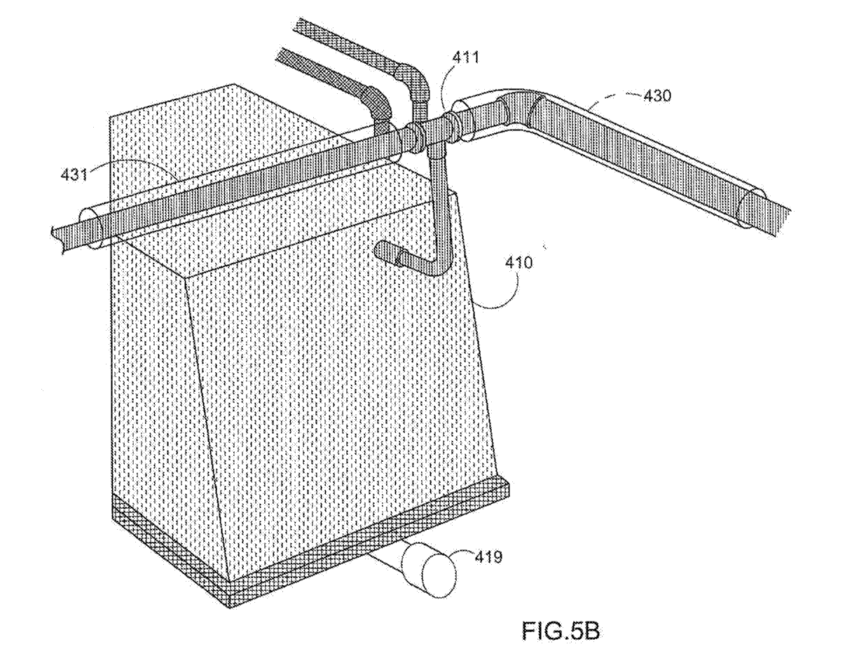

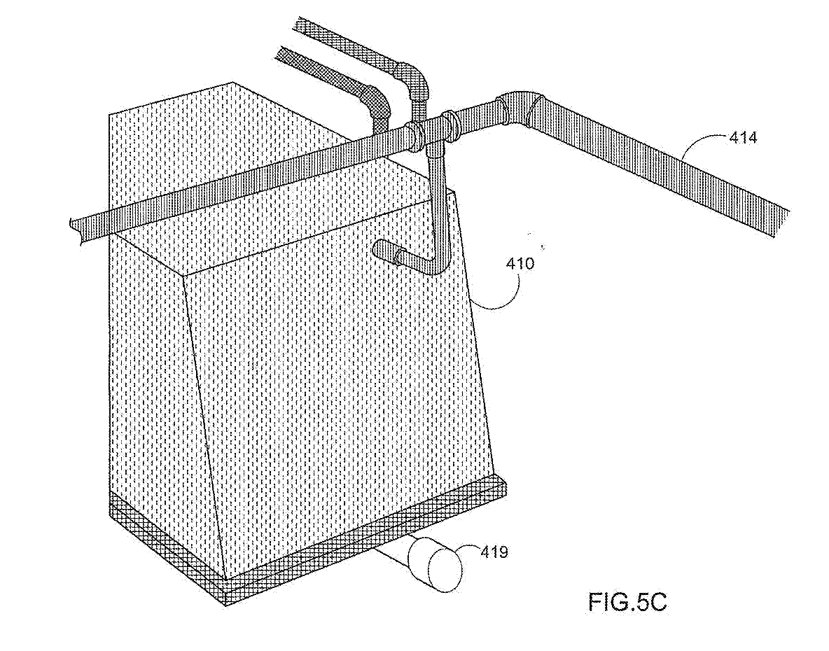

FIGS. 4A through 4E diagrammatically illustrate the extraction module flowchart. The process flowchart is sequentially presented in FIGS. 4A through 4e. FIGS. 5A, 5B and SC diagrammatically illustrate the extraction process for an outer layer covering a component, such as an outer layer of insulation on a pipe.

FIG. 5A diagrammatically shows boiler 410 and output pipes covered with insulation 430, 431. A smaller supply pipeline 416 is also shown. A second supply pipeline 418 is shown. As described later in connection with the extraction module flowchart beginning in FIG. 4A, FIG. 5B shows that the virtual thickness of insulation 430, 431 has been identified and, in FIG. 5C, the insulation has been virtually removed by the extraction module from the output line 414. In this patent specification, the red shading on output pipe line 414 (see FIG. 3) indicates that this output line carries hot fluid or hot slurry from boiler 410.

The extraction module begins in FIG. 4A, as identified in program header 210. In step 212, from the as-is scan data, the system visually identifies flange 411 at one of the pipe joints. Typically, the pipe flange is not covered by insulation 430, 431.

Once the pipe flange is identified either by optical image recognition software or image recognition software modules or manually by an operator of the present program, the computer program, using the as-is scan data, computes the thickness of the flange as noted in step 214. The as-is scan data includes point cloud scan data X, Y, Z and color and luminosity data. Point cloud data is stored in memory 54 in the central operating unit 10 of FIG. 1A. Based upon these data components in the as-in this data, the present computer system computes the thickness of the flange. Many monitored facilities color code equipment, piping and other items as noted above in the Component Data Tables. Therefore, when the as-is scan data is in the system, the component data is an indication of which components are coupled together or linked together by processes on the facility floor or deck. In step 216, a color match for the flange is associated with the pipe component data. See the Static CPT Table above. This is accomplished by comparing the as-and scan data for the pipe, particularly the color, with the flange component data.

In step 218, the system matches the linear pipe run, for example the linear pipe run in FIG. 3, pipe 414 running from boiler for 10 to the lower right-hand corner of the V-BIM display presentation. This pipe run image identification routine is based on color in the as-and scan data and the pipe component data. It is also based upon the as-is image of the pipeline flange to flange distance identified by image recognition software in the as-is scan. In step 220, the flanges are associated with the pipe type found in the pipe component data table. In step 222, the system makes an inquiry as to whether the pipe component data includes insulation or does not include insulation. See the pipe component data table above. In step 224, if insulation is listed in the pipe component data, then the system automatically matches the thickness of the flange to the thickness of the pipe. In this manner, the system automatically determines or estimates the inner and outer diameter of the pipe. Typically, industry standards provide that the thickness of the flange is similar or identical to the wall thickness of the pipe. Other industry standards are used to id the pipe size. Once the inner and outer diameter of the pipe is determined, the system can “virtually remove” the insulation image data from the as-is scan data and replace that insulation image with a virtual pipe BIM image, flange to flange. In this manner, as shown in FIGS. 5A to 5C, first insulation 430, 431 is visually identified, then flange 411 is visually identified, then pipe diameters are calculated, then a color match check is engaged (flange and pipe), then the image of insulation is removed (FIG. 5B), then a virtual image of the pipe run 414 is inserted into the scan image data (FIG. 5C). The result is a spatial match and a virtual data image.

In step 226, the next following flange or the preceding flange for the certain identified pipe is identified by the image recognition software. The software then makes a comparison between the pipe and the upstream or downstream flange, determines its color and its thickness, and matches the pipe data in the visually identified pipe run in the as-is scan. As noted above in the data component table, pipe types, colors, and thicknesses can be associated with these upstream and downstream flanges. In step 228, if these image identification points agree with each other or match, the system marks the as-is scan data as extract 1.0 and replaces the point cloud scan data, associated with the insulation, with the identified pipe run and inserts a “virtual pipe run”. The resulting image in the present patent specification is called the v-model pipe data. The V-model pipe data is then shown or displayed in the image with the appropriate component color code. Further, the identified pipe run is checked to see if the pipe run spatially matches the length in the as-is image scan of the pipe run on the platform or building floor. In addition to matching the length of the pipe run, the height and positioning of the pipe run at the upstream point of the pipe run and the downstream point of the pipe run is confirmed by color components and the associated mechanically connected flanges other types of structural components identified in the as-in scan data or as modified the extract 1.0 scan data. Hence, not only is component data checked upstream and downstream by the software but also dimensionally, such as lengthwise and thickness, and also positionally in the X, Y and Z location.

In step 230, if an error exists, then the extract 1.0 modified scan data is marked with an error marker (ERR) and the system seeks a user correction or modification. In step 232, the system repeats for all supply pipes. In step 234, the system repeats for output pipes. In step 236 the system repeats for intermediate pipelines. In step 238, the extract or modified as-is scan data is marked as final or “fin”. In step 240, the system returns to the general process program.

Returning to the general process flowchart and specifically to FIG. 2C, the system executes a supply process and flow match in step 138. This involves automatic color and component and size matching with the scanned extract fin or final data using “best fit” computer algorithms. In step 140, the piping and instrument diagram data (P&ID) is utilized. This P&ID data may be electronically delivered from the business customer, from the builder of the monitored platform or be a rough schematic of the floor or deck of the monitored platform or monitored facility taken before or after the as-is scan data. In step 142, the extract final data is confirmed with a supply flow match and the piping and instrumentation diagram data.

In step 144, the user confirms, modifies or inserts comments in the partially processed scan fin data. The user can view the original as-is scan at the same time or concurrent with viewing the scan extract final data and potentially concurrently viewing the piping and instrumentation diagram. In most situations, multiple users-viewers will review this data as noted in the system diagram of FIG. 1A.

In step 146, the component data tables are updated. In step 146, modifications are made to the scan extract final data are made. In step 150, the user and the viewers accept, modify or confirm these virtual images as v-data image and, in order to designate further processing in the general process, the modified data is designated as V-data 1.0. The as-is scan data is used as a primary source object-component map and is a source electronic e-file. The source as-is scan data is generally always available to the user-viewers in order to accurately confirm the v-data. The concurrently availability of the as-is scan data image and the final version of the v-data image is one of several important features of the present invention.

In step 152, the process is repeated for all output pipes and V-data 1.1 is created. In step 154, the process is repeated for all intermediate pipes and a visual display data, V-data 1.2, is created.

Some facility components shown in the as-in scan data are not readily automatically recognizable by image recognition software. In step 156, if needed for these unrecognizable components shown in the as-in scan data, these object data components (such as processing equipment other than pipes, containment vessels, mixers and burners), the user may obtain common building information data (BIM) for those unrecognizable images for further processing of the unique equipment. Sometimes the vendors of this processing equipment will provide standard BIM component data and the BIM images for the process equipment. The system either automatically or with some manual input replaces the image of the object-component in V-data 1.2 with the BIM equipment image and then creates the v-image data 1.3. In step 158, V-data image 1.3 is saved as static v-data image fin or final.

In step 160, the user locates or identifies (or confirms the previously software automatically identified), in the earlier processed v-data, control points and sensors in the v-data using displayed v-data. In this specification, sensors and detectors are identified as “process indicators.” The user, either manually or with the assistance of image recognition software, locates the process indicators such as meters, detectors, and sensors displayed in the v-data. Further, the user or image recognition software locates controllers for the process on the floor or deck of the monitored facility such as control valves, heater or burner controls, fuel line controls, resource supply lines, pipes, conveyors, cooler controls and other types of process controllers. The displayed v-data can be used or the as-is scan data, or both can be used in this identification or confirmation step. In step 162, the resulting data is stored as static plus indicator V-data 1.0. Alternatively or optionally in step 164, using the as-is scan data, machine recognition algorithms can be used to identify sensors and meters and other process management devices or process indicators. These are marked as “identified process indicators” in the pre-processed as-is scan data, and the process is repeated for process controllers. This is saved as “scan with indicator data” and “scan with control data.” Alternatively in step 166, using the process or piping and instrumentation diagram data (P&ID) and the static V-data final, the system matches the process indicator data in the P&ID with color and data object-component image and the serial position of the process indicator shown in the process and instrumentation diagram data. The serial location of indicators and controllers from the as-is scan must match the P&ID and, more importantly the then processed v-data. The software uses a best fit machine recognition algorithm or algorithms in order to match the static V-data final with the piping and instrumentation diagram data. Errors are identified to the user for modification or confirmation. The system repeats this machine match with process controllers. Ultimately, the system saves this modified v-data as “scan with indicator data” and similar “controller data.” Controller data relates to a controlled variable in the monitored facility. In the alternative step of 168, the system scans and saves the “scan with indicator data” as “static plus indicator V-data 1.1.”

In step 170, the user and other viewers confirm, modify or comment on the static plus indicator V-1.0 or 1.1 data virtual image. The user may also concurrently view the as-is scan data and further view the static plus indicator V-data image 1.0 or 1.1 and also view the process or piping and instrumentation diagram data. In this manner, the user and other viewers can confirm the accuracy of the V-data image with the as-is scan and the other control components. In step 172, the user and viewers update the component data tables for: the process indicator component data tables, and the process controller component data tables. In step 174, the users modify the static plus indicator V-data 1.0 or 1.1 as needed. This virtual image data is made to conform with the as-is scan in order to spatially match the virtual V-data image to the as-is scan. In step 176, the user accepts or refuses to accept the V-data virtual image, modifies that image or confirms the image. This virtual image data is saved as a V-data 2.0.

In FIG. 2G, a telemetry module or submodule is provided in header module 180. In step 182, the user inputs various resource data. This data is input into resource input data component tables. These input data tables include the type of resource, throughput parameters of the resource, input parameters, output parameters, temperature, dimensions, color, typical images of the resource or pre-processed item at each process stage, the initial, final and intermediate states of the resource (such as gas, liquid, slurry or solid) at each process stage. Other types of resource or process component data may be included in these component data tables. In step 184, the system obtains the virtual data image v-data 2.0. In step 186, the user inputs, either automatically or with machine assistance, and tags and links the process indicator component data tables with the resource input component data tables. This tag and link permits a user to select, for example, the image of the red output supply pipe 414 in FIG. 3, then select the “process component data table” control icon on the display of FIG. 11, and visually see the hot slurry or fluid in the pipe 414 by viewing the process component data table. In this manner, at various stages of the process on the deck or platform of the monitored facility, the user can see, immediately, the state of the processed material by concurrently viewing the process component data table and the spatially accurate virtual BIM display. See FIG. 11. The indicator data for the slurry shows real time temperatures and pressures. Fluid flow rates are calculated by inner diameter pipe dimensions. Flow restrictor valves are resistive elements in the P&ID. The software accounts for these factors and display RT process data from the dynamic component data tables. All this shown by cursor control and user command. Downstream RT data confirms or indicates an error condition.

A tag and link for the process controller component data tables and the resource input component data tables and the process indicator component data tables is also provided. These component data tables are saved in connection with virtual image V-data 2.0. An active “display now” link is provided in the process indicator image on the virtual data display v-data 2.0 to call up the unique process indicator component data table. A further “display now” link in the virtual image V-data 2.0 with the process controller image is found in the virtual image to link display of the unique process controller component data table.

In step 188, the user updates process indicator component data tables with maximum indicator values, minimum indicator values, error signal trigger values and further inputs the most efficient operational range values for the process indicator or sensor. Some of these component data table inputs may be automatically provided and pre-populated by importing information from the piping or process and instrumentation diagrams into the data tables for the current virtual data system. In step 190, the preprocessed virtual image data is identified as V-data real time 3.0. The term “real time” refers to values obtained from the process indicators (sensors) and the process controllers taking into account typical uploading data times from the monitored facility to the central operating unit 10 (FIG. 1A) and the processing of that variable or telemetric data by the central operating unit 10 as well as the data compilation times by compiler 60 and the presentation of the data via web platform module 62 ultimately to the users 30, 32 etc. Compiler 60 is the module formatting and creating the multi-window display in FIG. 11 with database data 56, 58, 58a and 58b in FIG. 1. Further, display delays via the telecommunications or Internet connection 9 are still within the definition of a real-time display of these telemetric data informational points. Delays in acquisition, processing and display are all accounted for in this realtime presentation of controller and indicator data. Estimates of realtime delays may be presented to the user-viewer in the display presentation shown in FIG. 11. In step 192, the system repeats the process for output component data tables. These output component data tables are tagged and linked with the various output images in the virtual image data and the process indicator component tables are linked with the output data tables. The process controller component data tables are also linked to the output data tables. In step 194, these data tables are saved as V-data real time 3.1 virtual image data. In step 196, the system repeats the process for intermediate product data tables. Tags from these intermediate product component data tables to the process indicator tables and the process controller tables are tagged and linked. In step 197, the virtual image with these updated component data tables is saved as the v-data real time 3.2. In this manner, the user when displayed with the v-data real time 3.2 image, can quickly locate an image of a control valve on the virtual image, select the control valve component data table and select the product component data table, select the process indicator data tables upstream and downstream and see in real time the status of the system in operation. This is one of the several important features of the present invention.

The telemetry module continues in step 198 and obtains in real time, data from process controllers, process indicators, and also in specially configured monitored facilities, images for online products. For example, these images may be obtained of input resources such as the number of empty bottles on input conveyor belt. Further images from intermediate products can be obtained such as images of bottles full of product. Finally, images of output products can be obtained such as images of bottles full of product. These images obtained in real time are obtained from cameras directed to the online products being input into the process in the monitored facility, intermediate images of the products and images of the output products. In this manner, the system can further identify the condition of actual products being processed by the monitored facility. This is another of the several important features of the present invention. These images are displayable upon command with the v-data BIM display.

In step 199, the system automatically imports and inputs resource data such as electrical power, water, etc. into component data tables. The system compares input resources with a number of output products sensed or counted by the system. In step 200, a data table display in real time is presented to the user upon command. These component data table displays include process indicator telemetry data, process control telemetry data and resource inputs versus output product data tables. In step 201, the user inputs, either automatically with pre-population of table data or manually, key performance indicator tables or KPI tables. Key performance indicators for input parameters, output parameters and intermediate conditions are often utilized by the business owners operating the facilities. These intermediate conditions may include conditions outside of the control of the business such as ambient environmental factors (the outside temperature about a facility), standard shutdown processes, and emergency shutdown processes. The key performance indicator data tables are assigned and linked to process indicator data tables and the process controller tables.

Also, real time online product images are also assigned and linked to the key performance tables.

In step 202, the system computes and compiles in real time the key performance indicator resultant in the KPI tables. In step 203, upon a user command, the user can see the process indicator telemetry data at each particular sensor or indicator by pointing the curser to the indicator image in the virtual BIM image (FIG. 11) and can also see the process controller telemetry tables and the key performance indicator resultants in KPI tables, as well as the as-is scan image. The real time online product input images, output images, and intermediate product images and processes are also visible. The V-data real time 3.2 virtual image of the system, actual telemetry and key performance indicators are all potentially visible upon user command.

In step 204, the user selects the v-data real time 3.2 data image (dynamic, with telemetry) and V-data 2.0 (static). The user can select the process indicator image on the V-data 2.0 (a static condition) to see the static component data table or a realtime telemetry image v-data real time 3.2. Processor indicator data is displayed from the static component data table or the realtime data is displayed from the process indicator dynamic data table. See static component data table database 56 in FIG. 1A and dynamic component data table databases 58, 58a, 58b. Controller data is also provided. The user can compare the real time virtual image and the static component data tables as well as the dynamic component data tables with the other real-time operations. He can also view the static V-data 2.0 virtual image. The user along with other viewers determines whether the virtual reality data or the augmented reality visualization data is accurate compared to as-is scan data. The virtual reality v-data real time 3.2 and the static virtual reality V-data 2.0 is altered as needed and resaved.

In step 205, the user selects the real time virtual reality data V-data real-time 3.2 as well as the process indicator image. In the same manner at an online product image, cameras and imaging devices can be placed in the monitored facility to capture the then-current image of the process indicator. The component data table for that process indicator and the actual real time image of the process indicator is then displayed or shown to the user. Alternatively, the user can select a process controller image from the virtual displayed image and the system will display the appropriate data table for that controller. The user can compare the real time process indicator and the process controller data to view the then operational range of the facility process as compared with the static process indicator data table. In step 206 the user confirms, adjusts or modifies the static virtual image data and the process ends in step 207.

With respect to FIG. 1B, in a current embodiment, access to the static or dynamic component data tables is provided by accessing the tools illustrated in FIG. 1B through the interactive viewer 25, the V.R. headset unit 28a and the A.R. display system 29a. The White Board (“wb”) tool permits the user to capture the then-current image of the as-is scan data or the processed V-BIM (either static V-BIM or the real time V-BIM), store the captured image in memory 54 (FIG. 1A), and write on the virtual board, add color, delete objects and otherwise edit the wb image. The processed wb image can then be shared, emailed, saved or deleted as needed. The Bim+ tool refers to the interactive display of the static or dynamic component data table. As is common in the prior art with standard BIM images, the user can interactively change the viewing perspective, focus in on certain items in the V-BIM, and withdraw to a larger view point. However the present invention permits the user to select an image of a component in the V-BIM and display interactively the associated static or dynamic component data table. The reference to BIM+ in FIG. 1B refers to this inventive feature of a data object linking the image of the component in the V-BIM (otherwise referred to as BIM+) with the component database 24, 56, 58. One current embodiment of the present invention permits the user to either (a) select the V-BIM+ and display the component data from the displayed image of the component or (b) use a tree-menu-sub-menu selection to pull up the component table. See FIG. 11, Function 1 or 2, block 519, which can carry an appropriate label for the menu tree. Reference to the Menu Tree in FIG. 1B refers to this functionality.

The user can also activate various communications functions such as Chat, and Video Conferencing. See FIGS. 1B and 11 (function block 526). The user can display the as-is scan with the Function: Scan (Point Cloud) in FIG. 1B. Earlier stored variable data is displayed by the Telemetric History function and realtime or then-current variable data is displayed by the Telemetric R.T. function in FIG. 1B. See also, FIG. 11.

The V.R. Tool box 28b in FIG. 1B permits the user to activate similar tools and also has an electronic presentation or e-learning tool-function permitting the user to display (a) a maintenance manual stored in the static component data table, (b) a user manual stored in that data table, (c) a stored FAQ session, or (d) a video regarding maintenance, use or an earlier stored record of a team session describing the issue currently attended to by the user. The simulator tool may either be the virtual editor function described later herein or may be the Animation Process described later herein.

With respect to gathering telemetric data from facility FAC 14 in FIG. 1B (see also FIG. 1A, customer computer system 16 and FAC 14), the sensor, meter or monitor can be hard-wired into the customer's facility (see FIG. 1A, system 16) or the sensor, meter or monitor can be in a wireless data communication with the customer's networked facility computer system. The sensor can be in a wireless connection with a mobile data gateway. Wireless data transfer mechanisms (radio, RF, ultrasonic, or infrared systems) and data transferred over other media such as a telephone or computer network, optical link or other wired communications like power line carriers can be used. Modern telemetry systems take advantage of the low cost and ubiquity of GSM networks by using SMS to receive and transmit telemetry data. There are industry standards defining the electrical characteristics of drivers and receivers for use in communications systems. See standards by the Telecommunications Industry Association and Electronic Industries Alliance (TIA/EIA). A typical telemetry network is based on the following components: Sensors/Actuators; Remote Terminal Units (RTU); Base stations—also known as receivers, gateways or central collection points; and SCADA software, usually dedicated supervisory control and data acquisition (SCADA) software. SCADA is a control system architecture that uses computers, networked data communications and graphical user interfaces for high-level process supervisory management, but uses other peripheral devices such as programmable logic controllers and discrete PID controllers to interface to the process plant or machinery. The operator interfaces which enable monitoring and the issuing of process commands, such as controller set point changes, are handled through the SCADA supervisory computer system. However, the real-time control logic or controller calculations are performed by networked modules which connect to the field sensors and actuators.

Telemetric data obtained by central system 10 (FIG. 1A) from FAC 14 and B-computer system 16 accesses central data collection or distributed data collection points in these prior art telemetric systems.

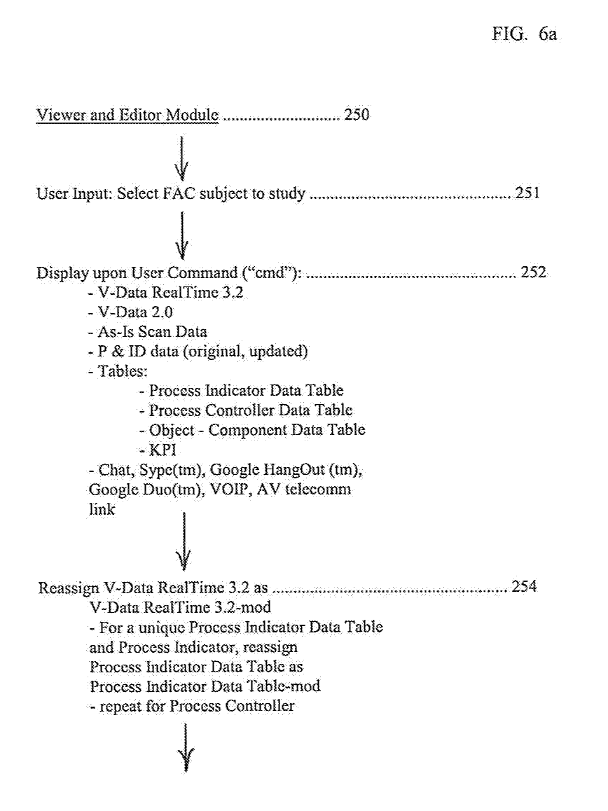

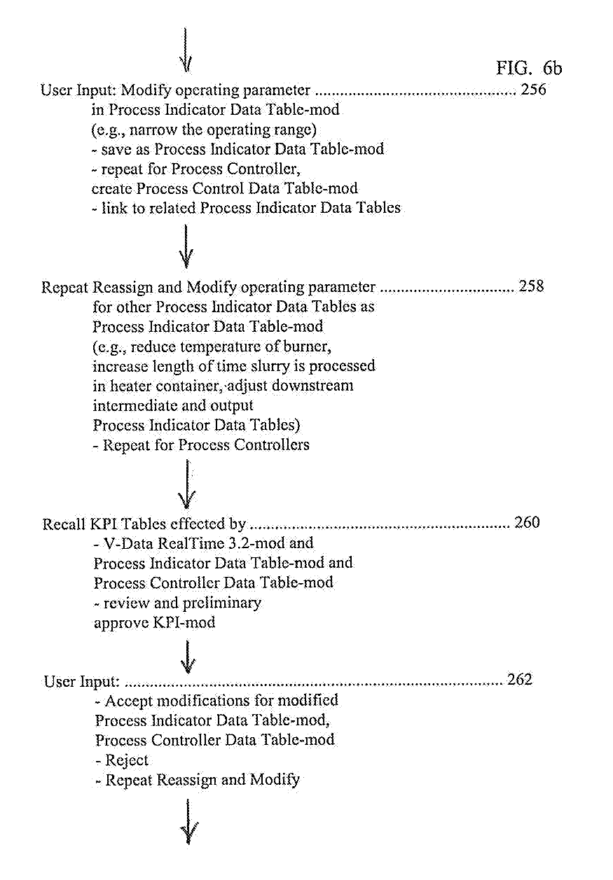

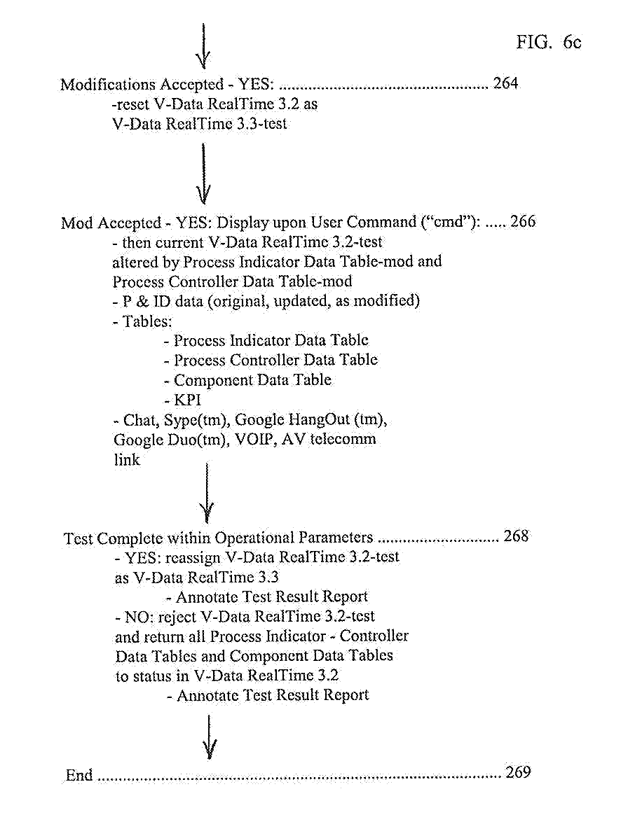

FIGS. 6A to 6C diagrammatically illustrate a viewer and editor module as a process flowchart. The process flowchart is sequentially presented in FIGS. 6A through 6C. The viewer and editor module is indicated in block 250 of FIG. 6A. In step 251, the user selects a facility subject to his or her study. In step 252, the user can display upon command the v-data real time 3.2 or the static image V-data 2.0 as well as concurrently view the as-is data scan. See FIG. 11 and BIM data window 530 and as-is scan image 533 (as-is scan image is referentially indicated in FIG. 11). In step 252, the user can also display the process or piping and instrumentation diagram data as originally presented and input or as updated by the system operator. Tables are available for display for the process indicator data tables, process controller data tables, the data object-component data tables, and the key performance indicator tables. The user can engage in communications with other users or viewers using chat or audio Skype™ or audio and visual Skype™, Google Hang Out™, Google Duo™, voice over Internet protocol or other audiovisual telecommunications links. An electronic white board can be included as part of the telecom function.

In step 254, the user can reassign the real time v-data real-time 3.2 as V-data real-time 3.2-modified. The “modified” data is test bed data. For a unique process indicator data table, and the associated unique process, the user can reassign the indicator data is indicator data table—modified and repeat the same for an associated process controller. This reassignment to a “modification” is permitted by selecting the edit function in the system. See FIG. 11. These changes to the indicator data tables and controller data tables are only temporary and hence are identified as modifications (“mod”) in the system.

In step 256, the user inputs a modified operating parameter in the process indicator data table and the controller data table. For example, the user may want to narrow or reduce the operating range of an indicator and have the relevant process controllers change in the in a similar manner to meet the narrowed indicator range. These are changes to the dynamic component data tables and are identified as “mod” until formally approved by the user. There are links between the indicator data tables and the controller data tables to automatically alter data points.

In step 258, the user reassigns and modifies operate parameters for various process indicators and process controllers. For example, the controllers may reduce the temperature of a burner, increased the length of time slurry or fluid is processed in a heated container, and adjust the downstream intermediate and output process indicator data tables. These changes are stored as temporary modifications in these data tables. Similar modifications are made to the controllers. In step 260, the user recalls the key performance indicator tables affected by the modified v-data real-time 3.2-MOD and the process indicator modified data tables and the process controller modified data tables. The user reviews preliminary virtual results and approves the key performance indicator modifications. In step 262, the user accepts the modified control data and indicator component data tables or rejects some of this data and repeats the reassignment modification.

In step 264, the user accepts the modifications in the system sets a virtual testing of the entire system as v-data real-time 3.3-test. In step 266, after the modifications are accepted and the testing of the entire system is processed by the virtual reality software in accordance with the principles of the present invention, the user may permanently accept, reject or modify the virtual test. The process or piping and instrumentation diagram is updated or modified as needed in the virtual test. Tables are updated for the indicator data, the controller data, the component data and the key performance indicator data tables. At this time, the user actively engages telecommunications with other viewers. In step 268, the user determines whether the virtual test was successful and then, the user in step 268 determines whether the virtual test was complete and virtual operations proceeded within the operational parameters. If yes, the test virtual test data V-data real-time 3.2-test is renamed V-data real-time 3.3. An annotated virtual test result report is generated. If the virtual test was not a success, the v-test is rejected. If the virtual test is accepted, the system alters the component data tables to reflect and implement the edits of the indicator data tables and the controller data tables. This resultant output command set is then applied to the actual monitored facility in order to change in real time the operating parameters of the facility.

FIG. 11 diagrammatically illustrates a display showing the various as-is scan data, BIM virtual display, and displays for static and dynamic component tables. In FIG. 11, on the left-hand side, in region 514, administration type functional active display regions 516, 518 and 520 enable the user to redirect display 510 to the homepage, to call up administration function 518 or to seek help 520. On the right-hand side, a “tool” active functional region 517 permits the user to activate a toolbar. Functional active regions 519 are identified as “function one” and “function two” on the right-hand side of display 510. A view function is provided for a “facility wide” display and a function edit and a function cloud-access and a telecommunications function chat or Skype™ functions are shown. See view 251, FAC 252, edit 253, cloud-access 254 and telecom 256 on the right-hand side of display region 510. As an example of Function 1, a menu tree can be called up by the user, listing, in tree or menu format, various layers of components and drill-downs to specific components and further to the relevant static data table and/or the dynamic data table. Function 1 and 2 can be customized for the particular facility or vessel. For example for a vessel, menu listings for engine room, cargo deck 1, 2, 3, control room, pump room, etc. Additionally, the specific name of the component may be shown in the menu (such as water supply pump for boiler on deck 4). Activation by the user of the menu component for “water supply pump for boiler on deck 4” causes the system to call up the image of the water supply pump for boiler on deck 4 and a perspective view of the deck 4 region about the water supply pump. In this manner, the system and method is highly dynamic, permitting either (a) access to the data tables via curser control on the displayed V-BIM image itself (a data object link in the V-BIM, linking to the data tables); or (b) accessing view the menu tree the vessel, then the deck, then the list of components on the deck, then the water supply pump. Therefore, the BIM+ is highly interactive. Additionally, Function 1 and 2 can activate the Tool Box routines or applications (APP) shown in FIG. 1B.

In the interactive middle display window 512, the user has selected a virtual image BIM 531 within intermediate sized window 530. The as-is scan data image 533 is referentially indicated in the underlying window 532. One of the several important features of the present invention is the concurrent, side-by-side or windowed display of both the V-BIM and the as-is scan data (sometimes referred to as the point cloud data). This enables the user to confirm (or not) that the V-BIM accurately spatially maps to the as-is scan or point cloud image. The user can zoom in or zoom out of the point cloud image and-or the V-BIM image. The user has previously opened facility component data table 536, the facility deck 11 component data table 538, an “all component” data table 540, an “all valves” component data table 542, and specifically controller valve 1 component data table 543. Both the static component data table and the dynamic component data table for controller valve 1 is shown. Alternatively, the static component table may be separate from the dynamic component table. These tables may include component maintenance manuals, operating manuals, tutorials on installation and operation and maintenance. E-learning tutorials are available from the component databases. Although the present system typically employs a high level of data security (to avoid a cyber attack taking over or altering the control points of the system and processes under the control of the V-BIM-realtime), in low security systems, the data tables may have a hyper link to outside electronic data sources such as You-Tube tutorials, operator manuals, etc. but it is not recommended that these low security systems active controls on the monitored facility.

In window 544, a graphic representation of a process indicator meter is shown. The graphic indication at window 546 shows the meter's arrow within normal operating range. Region 548 shows that this process indicator is measuring a process associated with controller valve 1. In region 552, “control point 1” is shown with a value window 554. With respect to graphic illustration of the sensor or indicator in window 544, the actual value “83” is shown in display region 550.

Another important feature of the present invention (one of several such features described herein), is a “Measurement Tool” or function. When the measurement tool is activated (see Function 1, 2 in FIG. 11 (or may be the edit function)), the user can call up the as-is scan (otherwise known as the point cloud image (herein the “PC image”)) and select a first image point on the PC image, then select a second point on the PC image and then the system will automatically calculate the actual physical distance between the points (the system being earlier mapped with dimensional units, for example, indicating that the pipe image is 9 feet above the floor, and the system adjusting the displayed image to that dimensional unit factor). Upon user command, the measured spatial dimension is saved in the appropriate component table. In this manner, the measurement tool can calculate distance, pipe outer dimensions, flange dimensions, area (with an appropriate “calc area” function pre-selected by the user) and curvatures (by selecting radial dimensions). Importantly, the measurement data can be exported to other electronic files outside of central system 10 in FIG. 1A.

A further important feature of the present invention, in addition to the others described herein, is the overlaid or addition of animation to the V-BIM realtime image. The animated image is taken from an animation image library stored in memory 54 in the central system 10 of FIG. 1A. The Animation Module engages the following steps and assumes that an animation image library is available to the user. Once the V-BIM realtime is called up, the user selects the image of the component subject to the animation process. This component must be subject to some type of dynamic event as indicated in the relevant dynamic data table. For example, fluid flow through a pipe or fluid level in a boiler can be animated by showing levels of flow in the pipe or a fluid level in the boiler. The boiler level can be either measured by a fluid level process indicator or computed based upon supplied fluid, the temperature and the pressure in the boiler. The pipe fluid level can be estimated by pipe size (inner diameter) and an estimation of fluid flow. Estimates of these changeable elements are acceptable because the realtime valve positions and fluid flow rates, temperatures, pressures and fluid levels are displayable upon command with the V-BIM (sometimes called herein the BIM+). The animation is an exemplary image of the condition of the dynamic condition of the resource in the static component. The user selects the dimensional points in the V-BIM for the animation overlay. One example of dimensional point selection is, in connection with the boiler, the user selects a volume defined by the boiler container, and then selects the lower, nominal or “permitted lower limit” boiler level, then selects either the input flow sensor-indicator related to that nominal boiler level or the temperature-pressure indicator levels. The user then selects the upper permitted boiler level and the related input flow sensor-indicator related to that nominal boiler level or the temperature-pressure indicator levels. At least two dimensional points are required for each animation, one high level and another low level and these two dimensional points must be tied to either a control point in a controller or a measurement point in a process indicator. The system may automatically fill in the animation image space by edge detection of the inside containment space of the boiler. For the pipe, an upper and lower animated level is needed along with the controller or indicator set points. The system can automatically calculate the length of the pipe because the V-BIM spatially matches the pipe length between joints or connections with other pipes or flow sensors or valve controllers. Once the two dimensional points are selected and the volume of the V-BIM component image is determined (automatically or manually), the user, upon command, can animate the V-BIM realtime image with the overlaid animation. Additional animation types include conveyor belts and product output images. Once the animation is set-up, the dynamic component tables are linked by data objects to the animation images such that the amination images overlaid on the V-BIM match the processed variable resource passing through or over the static component.

Another important feature of the present invention (one of many described herein), includes a Data Import (“DI”) function. Although the V-BIM model described earlier covers telemetric concepts that the process sensors-indicators and the process controllers have both static data (where they are located on the FAC, and to what they are connected to) and dynamic data (indicating a current control point, minimums, maximums, historic data; sensor levels and related minimums, maximums, historic data), the system and method operates with a Data Import (“DI”) function which accepts data from mobile sensors or detectors at the monitored facility or FAC. Therefore, in connection with FIG. 1B, sensor 11 may be a mobile detector and input/output module 15 can be a wireless network connection sensor 11 first to the FAC platform's local computer network and then ultimately to central system 10 in FIG. 1A. The DI Function includes the following steps or modules. (1) The database 58 is initialized with an input data object and data tables to match received component data. The input data object in the table for this DI Function enables the upload and further data population from the mobile detector. For example in connection with a pipe in the remote FAC far distant from the central system 10, database 58 would include data tables with fields or data elements for pipe name, fabricator code, thickness, seamless (Y/N), material type (pull down menu), insulated (Y/N), type of fluid or gas carried by the pipe (menu driven), state of processed resource (gas, slurry, liquid), etc. (2) Typically, the mobile sensor-detector carried by the data acquisition person or mobile worker about and around the FAC is used to selectively gather data on a certain component. For example, an ultrasound (US) detector can be used ay multiple points along a pipe run to detect the thickness of the pipe at those various points on the pipe run. The detector uploads the acquired data via a wireless communications network to the FAC-based computer system. (4) The FAC-based computer system has a thin client program which enables the FAC system to gain DI Function upload access after the FAC system clears and passes security access protocols with the central operations computer system 10. (5) Once security is cleared, the FAC system 16 or 14 (FIG. 1A, 1B) uploads the acquired data into computer processor 50 in central system 10. (6) Processor 50 then reformats the uploaded acquired data and imports the same into the database 24 or database 58 (the static component database or the dynamic component database, or both, dependent upon the class or type of acquired data and the static component sensed by the detector or the state of the dynamic resource sensed by the mobile detector. If the thin client program on the FAC computer has pre-formatted data tables to match the tables in database 24, 58, processor 50 need not reformat the data. Data conversion from detector-sensor 11 to a format compatible to component table is well understood in the industry. Importation of the acquired mobile data into the database tables is then used in the V-BIM. (7) Best practices include an appropriate data transmission check prior to inputting the uploaded acquired data into database 24 or database 58.

An enhancement of this DI Function is the acquire data, remotely with a mobile detector, and display the results in substantially realtime on the V-BIM. From a data processing and data display standpoint, the realtime display of newly acquired mobile data is very useful. A mobile worker, carrying a tablet computer displaying a V-BIM can be engaged in a telecom session with a manager on the business computer system 16 who also sees the same V-BIM, all in realtime. The manager can direct the mobile worker to detect thickness on a red pipe by: start at the flange next to the green valve near the door on floor 7 in pump room Xray, and place and use the US detector at a defined location (on the red pipe next to the flange downstream of the green valve). Upload US data to the V-BIM system. Move the US detector 12 inches downstream along the red pipe run. Repeat the US data acquisition. Repeat the US sensing over each 12 inch pipe segment until you reach the gray flange at the end of the red pipe. From this example, the V-BIM component data table has been pre-loaded with the red pipe, green valve component data, the colors on floor 7 in pump room Xray on the V-BIM match the as-is scan colors which, in turn, match the colors on floor 7 in pump room Xray. The uploaded newly acquired mobile data is automatically used to populate and update the data tables. Since the monitoring of corrosion of pipes and piping components is critical, the present invention can be used to (i) direct the mobile worker to correctly and accurately gather data and (ii) the uploaded newly acquired mobile data is instantly available to the business or the business' contractor for analysis and immediate corrective action, if necessary.

In addition to the foregoing, the DI Function can be used to build out and initially populate the component data tables. A baseline compatible BIM is obtained and stored in memory 54 of central system 10. The baseline compatible BIM is then spatially altered to match the as-is scan, either automatically using image processing tools or manually. This generates V-BIM ver1. A current P&ID is used to cross-check and confirm the V-BIM ver1. Changes are made to create V-BIM ver2. Colors from the as-is scan are transferred to the BIM and V-BIM ver3 is created. Component data is obtained from the manufacturers of components in the process. Data tables for the BIM are matched to the uploaded manufacturer data (V-BIM ver4). A mobile worker is then present at the FAC to acquire data, remotely with a mobile detector, and display the results in substantially realtime on the V-BIM (V-BIM ver5). The user, with editing permissions, directs the mobile worker to acquire data by both (i) telecom delivered instructions; and (ii) visual directions shown on the as-is scan visible on mobile worker's computer tablet; (iii) while the user-editor formats the data tables to match the uploaded newly acquired mobile data. The user-editor in realtime on the as-is PT scan data measures pipe length, doorway sizes, platform heights, width of hallway passageways, and directs the mobile worker to acquire data on static components which for the V-BIM.

In a further enhancement, rather than start with a compatible BIM, the system operator can start with CAD data, then convert the same to a BIM. In this manner, the initial compatible BIM replicates the CAD image data, but the initial compatible BIM is processed in an iterative manner as discussed herein.

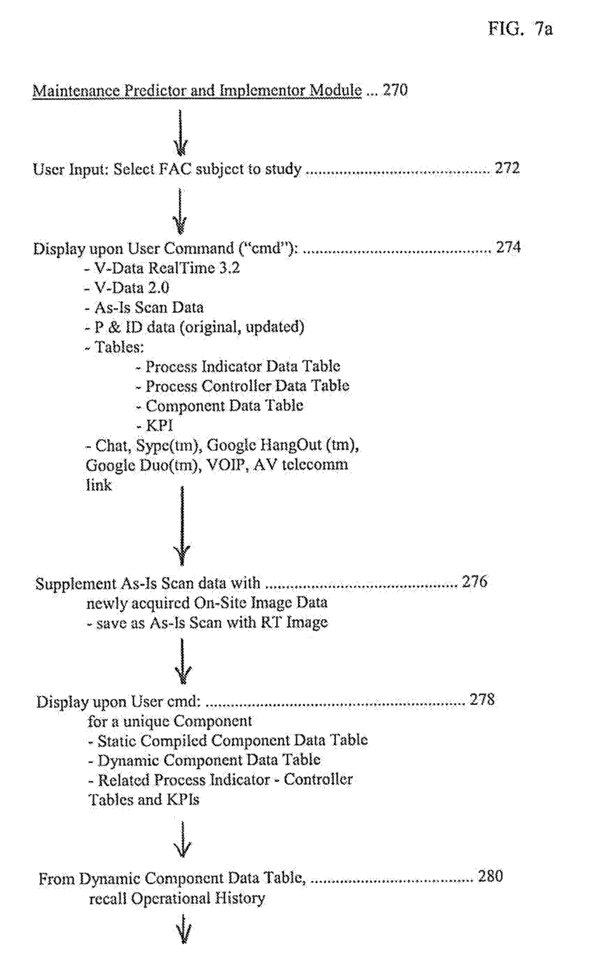

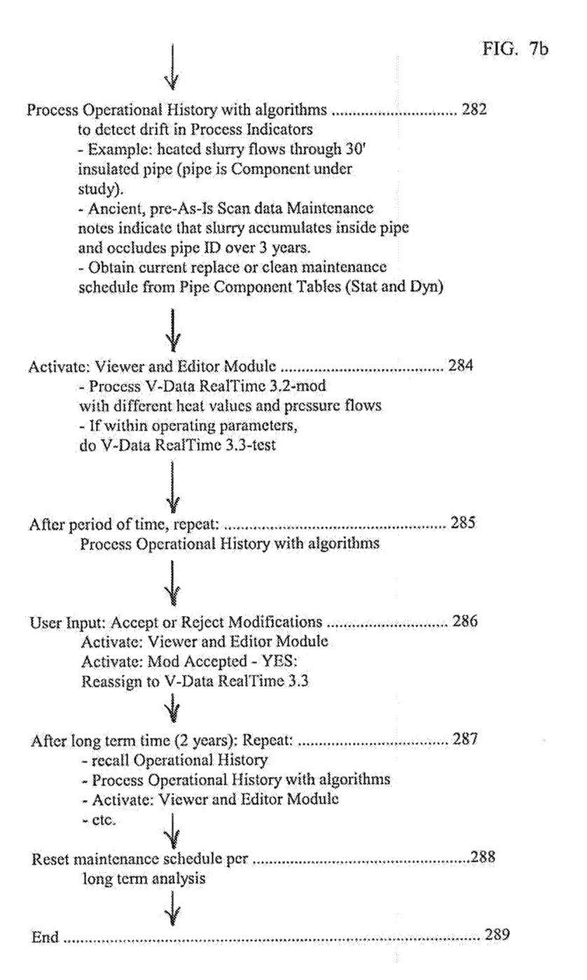

FIGS. 7A and 7B diagrammatically illustrate a maintenance predictor and implementer module as a process flowchart. The process flowchart is sequentially presented in FIGS. 7A and 7B. Block 270 in FIG. 7A identifies the beginning of the maintenance predictor and implementer module. In step 272, the user selects the facility subject to study. In step 274, the user upon command opens up the v-data real-time visual display and the v-data 2.0 (static) visual display and the as-scan data visual display as well as the process or piping and instrumentation data (original or updated) as well as tables for process indicators, process controllers, other component data tables and key performance index tables. A telecommunications function is also provided to the user upon command. In step 276, the as-is scan data is supplemented with newly acquired on-site image data. The as-is scan data is then saved as “as-in scan with RT image.” In step 278, the user upon command selects a unique component in the visual displays. The static component data table is displayed and the dynamic component data table is also displayed and the relative process indicators and process controllers and key performance indicator tables are also displayed.

From the dynamic component data table in step 280, the operator recalls the earlier operational history. In step 282, the system processes the operational history with algorithms to detect, for example, a signal drift in the process indicator under study. For example, heated slurry flows through a 30 foot insulated pipe and the pipe is the component understudy, the user understands based upon earlier provided maintenance data for that slurry carrying pipe that the maintenance routine requires that the pipe be cleaned or replaced every three years. Effectively, as an example, material accumulates inside the pipe and occludes the pipe inner diameter over this three-year period. Another example involves the thinning of pipe due to corrosion caused by fluid, gas or slurry passing therethrough. Corrosion is a serious problem in many plant facilities. The signal drift in the flow indicator or resultant predicts a long-term maintenance event. The user also obtains the data tables for replace or clean maintenance for that particular pipe component. Both static and dynamic component tables are utilized. These tables include maintenance data. Ideally, dynamic component tables contain maintenance time frame data.

In step 284, the user activates the viewer and editor module. A process is conducted to enable a virtual real time testing as a modification with different heat values and different pressure flows through the subject pipe component. If the modifications in a virtual test fall within operating parameters, the test data is converted to real time operational control data. In step 285, after a significant period of time, for example, after a three-month period with the revised operational controls, which is reasonably related to the three-year maintenance cleaning period for the pipe component understudy, the system repeats the previous routines for “process operational history with the algorithms” and activate the “viewer and editor module.” In step 286, the user accepts or rejects the new modifications from the virtual test. If they are accepted, the modifications are assigned and operationally applied as V-data real-time 3.3. Control settings for the controllers and new process settings for the indicators are implemented in the facility.

In step 287, after a very long period of time, for example after a one year period from the original virtual test and operational implementation and nine months after the implementation of the new control parameters for this pipe component, the system recalls the pipe and related system operational history and processes the operational history with algorithms (see above, the drift signal analysis). The system activates the viewer and editor module in order to change the process control points. In step 288, the maintenance schedule is then reset to reflect the longer-term analysis. The process ends in step 289. If maintenance can be extended to a four year cycle, this improves operational performance and improves KPI.

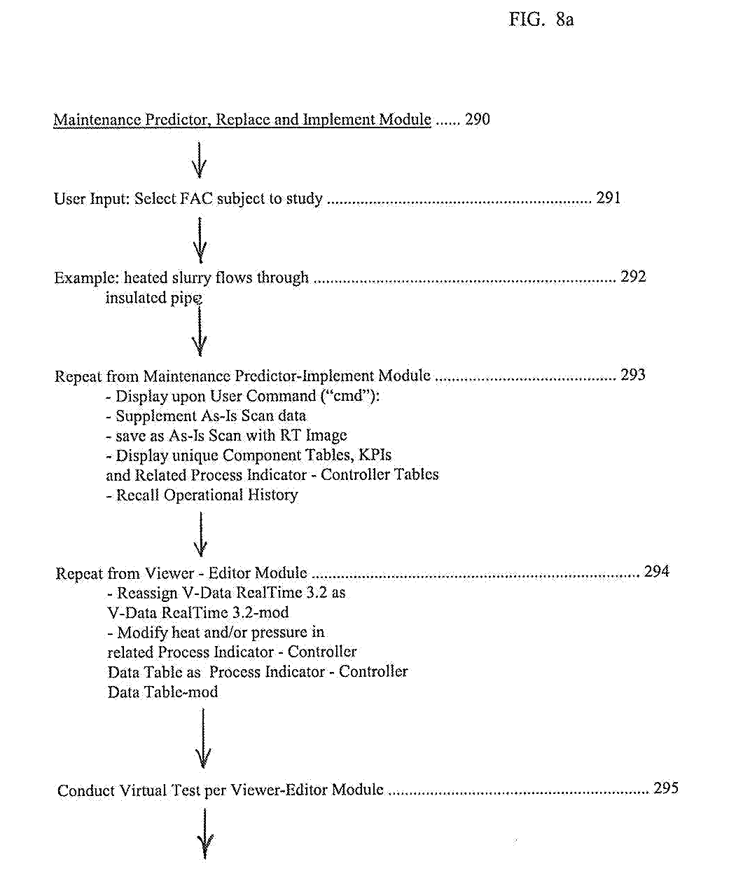

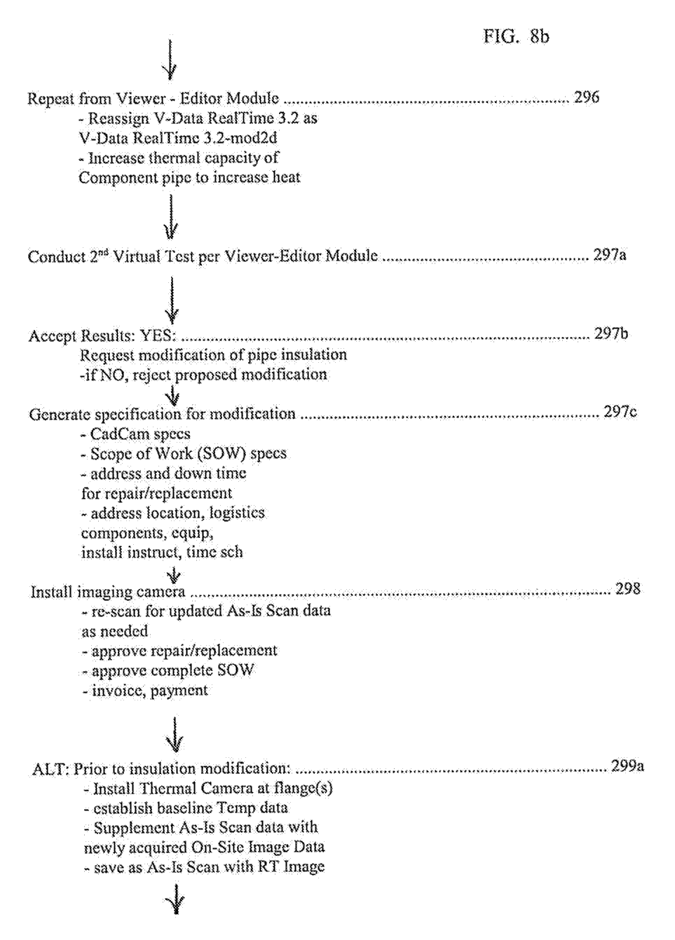

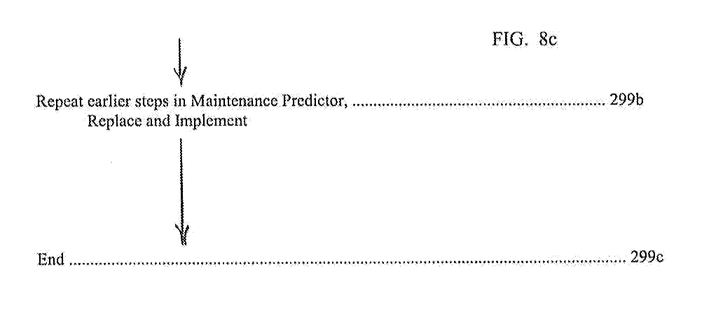

FIGS. 8A though 8C diagrammatically illustrate a maintenance predictor, replace and implement module process flowchart. The process flowchart is sequentially presented in FIGS. 8A through 8C. This module initiates in block 290 and in step 291, the user selects the facility subject to study. In step 292, as an example, the module studies heated slurry flow through the insulated pipe as the component under study. In step 293, this module repeats the maintenance predictor and implementer module. The user selects upon command the as-is scan data and supplements this displayable data as supplemented as-is data. This is saved as the “as-is scan with RT image data.” The user displays a unique component table under study and the associated component tables and key performance indicator tables as needed. The system also recalls operational history for the component under study. In step 294, the system repeats the viewer and editor module. Reassigning the virtual real-time data 3.2 as “virtual real-time data image 3.2-modification.” The user modifies the heat and/or pressure in the component under study and alters the process indicator and controller data tables as needed. These changes are stored as modified indicator process points and controller points.

In step 295, the user conducts a virtual test with the viewer-editor module. In step 296, the user repeats the viewer-editor module and reassigns the virtual data 3.2 as “virtual data real-time 3.2-modification—2-D.” The user may increase the thermal capacity of the component pipe under study to increase the heat stored in the slurry passing through the pipe. In step 297A, the user conducts a second virtual test in accordance with the viewer-editor module process. In step 297B, the user accepts the virtual test data and requests modification of the pipe insulation. More insulation about the pipe will increase the slurry heat passing through the pipe. If no, the user rejects the virtual task. In step 297C, the user generates a specification for modification of the insulation over the component pipe. The system generates computer aided design-computer aided manufacturing CAD/CAM specifications, the system can also develop scope of work SOW specifications. A report is produced which deals with downtime issues and process displacement issues for the repair, replacement or re-installation of the insulation over the subject pipe component. The system can also address logistics in bringing a new pipe into the deck or floor of the designated facility. Also the report addressing items like bringing the pipe through doorways and openings, shipping time, movement of equipment to accommodate replacement, installation instructions and generating time schedules. All these items are facilitated by the use of the virtual display v-data which substantially spatially matches the physical facility. The as-is scan shows the as-built condition. The static v-data shows the physical BIM limits and the v-realtime data shows the operational conditions which must be handled to facilitate a repair, replacement or renovation of equipment at the facility. The as-is scan data confirms static conditions like the size of doorways.

In step 298, the user may install an imaging camera during this repair or renovation event. The new data is saved as an updated as-is scan data. The system operator can then approve the repair or replacement, approve a completion of the statement of work, generate an invoice and, if needed, facilitate payment to the vendor conducting the replacement activity. In step 299A, as an alternative, prior to installation of the insulated pipe, the user may install thermal cameras at the flange connections for the subject pipe component. The user can also establish baseline temperature data from these thermal cameras. The as-is scan data is supplemented with this temperature data (updated as-is scan) and classified as newly acquired on-site image data. This display data is saved as as-is scan with RT image data. In step 299B, the system repeats the earlier steps in the maintenance predictor, replace and implement and in step 299C, the module ends.

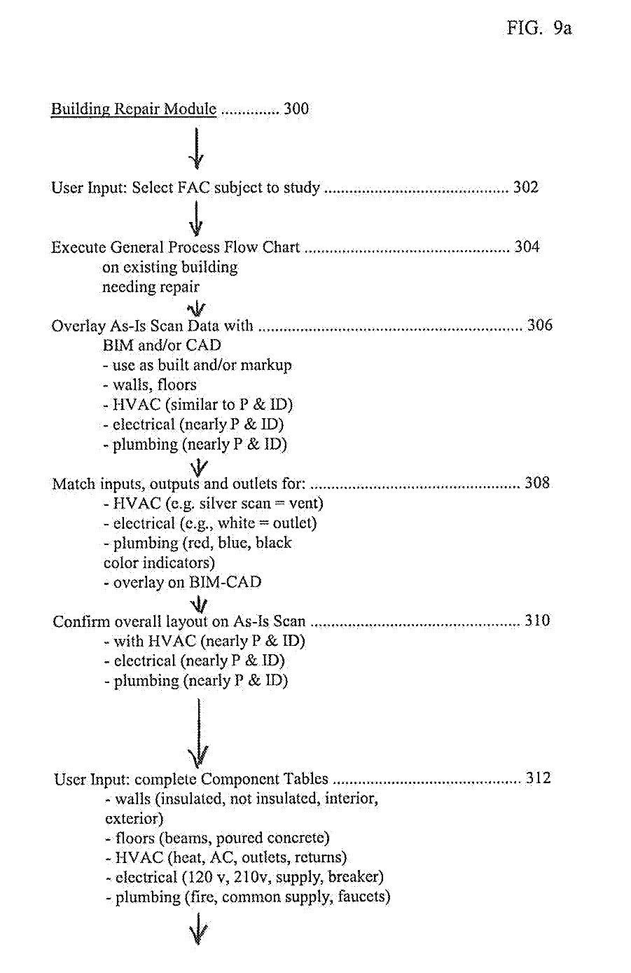

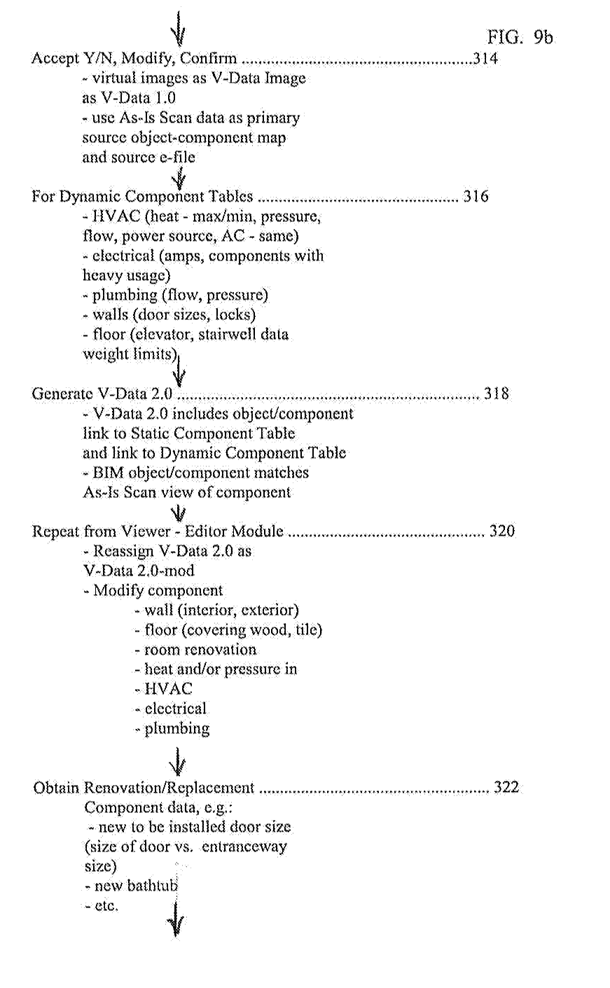

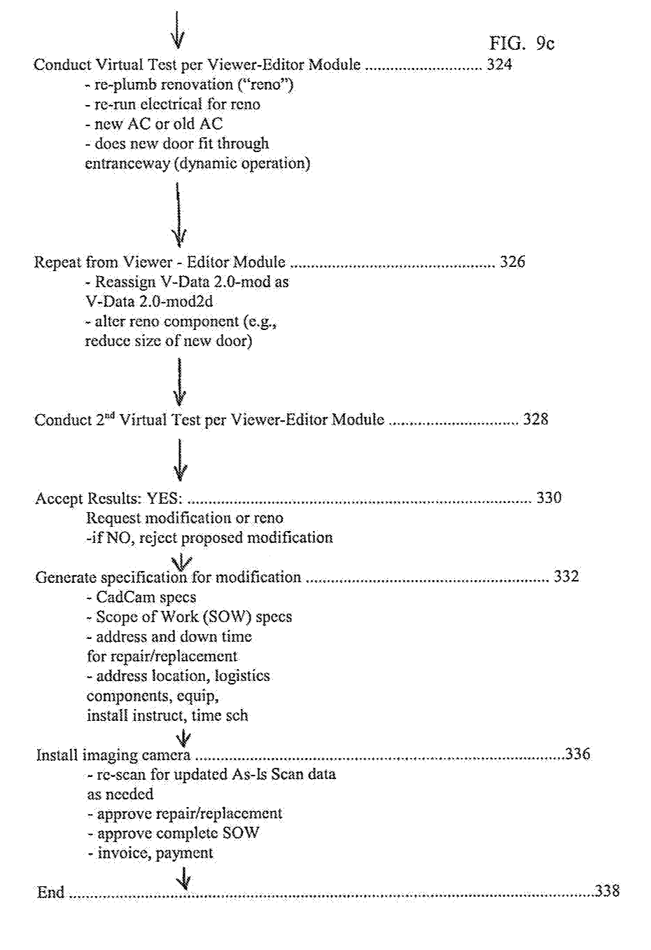

FIGS. 9A to 9C diagrammatically illustrate a building repair module as a process flowchart. The process flowchart is sequentially presented in FIGS. 9A through 9C. The module starts in block 300 and the user, in step 302, selects the facility subject to the study. In step 304, the user executes the general program process flowchart on the existing building-facility needing repair. In step 306, the user employs as an overlay, the as-is scan data with BIM data. The user may also use the as-built data or the markup data for the facility. Walls, floors and other components are identified in the facility subject to the renovation or repair. Heat ventilation and air conditioning component data is also obtained. This is similar to piping and process and instrumentation diagrams. Electrical diagrams and plumbing diagrams are obtained. In step 308, the system matches the inputs and outputs and outlets for the heat ventilation and air conditioning, the electrical, plumbing, etc. and overlays the same on the BIM virtual model or CAD drawings. The CAD drawings can be a starting virtual BIM model. The important point is that the virtual BIM model be spatially mapped to the as-is scan data and accurately show all components in the facility. Colors can be assigned to these component data tables.

In step 310, the user confirms the overall layout and spatial aspects matching the virtual BIM with the as-is scan data. Image recognition software is used in this process. Further, the user confirms with the process and instrumentation diagram the various sub components such as heat, ventilation and air-conditioning component, electrical component and plumbing component. In step 312, the user completes the equipment component tables. These data component tables include walls (insulated or not, interior, exterior), and floor component tables showing whether beams are used or are poured concrete. Heat, AC and ventilation component tables are created as are electrical and plumbing and other major components (lighting, windows, etc).

In step 314, the user accepts or modifies and confirms the proposed virtual BIM data. The virtual images are identified as v-data 1.0. The as-is scan data is the primary source and object-component map and is a source electronic file for the entire system. In step 316, for the dynamic component tables, include, for example, for HVAC, data on the maximum and minimum heat values, pressure, flow, power source consumption etc. are collected and stored in memory. The same is true for electrical subsystems regarding amperage, and components subject to heavy power use. As for plumbing in the dynamic component tables, the flow and pressure through piping is important. With respect to walls, the door sizes and locks are dynamic functional items. The floor tables include dynamic items such as elevators, stairwell data and weight limits.

In step 319, the system generates v-data 2.0 which includes a “display now” data object-component link to static component tables and links to dynamic component tables. The data object link permits the user to move the curser on the display 531 (FIG. 11) to the component. When the user is on the component, the link enables the user to pull up the component data tables. There are two ways to pull up this component data. In one method, the user selects a “show component” function on the active display 510 and the relevant component table appears whenever the curser is over or at the displayed component in the image 531 in window 530. In a second functional process, when the user place the curser over a component image in v-display 531, the user “right clicks” the mouse and the component table then appears on display 510.

The BIM data object-component spatially matches the as-is scan view of the component. As discussed earlier, in construction, BIM data objects and BIM data object models are available for various types of construction components. These BIM models can be imported and added to the virtual data built by the system and edited by the user. Further, component data tables may be available from the vendors of the component.

In step 320, the user activates the viewer-editor module and reassigns the virtual data 2.0 as virtual data 2.0-modification. The user virtually modifies elements such as walls, floors, room renovation, HVAC, electrical and plumbing. Data tables are changed and marked as “mod” data. A virtual plan is generated as virtual data 2.0-modification. In step 322, the replacement data for the components are created as replacement component data tables. For example, if a new interior door is needed, the size of the interior door is compared with the outer door entrance way for the existing facility. If the new door size is less than the existing entranceway, then the new door is accepted for the renovation. A rejection requires user modification. As noted above, entranceway data is a dynamic compounded table data associated with the floor. The system may automatically note conflicts with either static component tables or dynamic component tables. For example, installing a new AC unit which uses 40% more electrical power may exceed the electrical static or dynamic component data table. The system would alert the user to the “exceed maximum” data point in the component table.

In step 324, the user conducts a virtual test of the modifications with the viewer-editor module. Other renovations such as plumbing, electrical, as well as air-conditioning and heating are conducted. Some of this analysis involves a dynamic operation of moving the replacement equipment through various dynamic or static conditions. For example, the renovation may need electrical power in excess of the power on the floor of the facility. Therefore, a generator must be brought in for the renovation. The gas-powered generator may need access to the ambient environment for proper operation. Therefore the renovation equipment is compiled as both static component data tables and dynamic component data tables.

In step 326, the user repeats the viewer-editor module and assigns virtual data 3.0-modification is virtual data of 3.0-modification-2D. The user alters the renovation component data as needed. In step 328, the user conducts a second virtual test with the viewer-editor module. In step 330, the user accepts the renovation results or rejects the results. In step 322, if the renovation or replacement is accepted, the software system can generate CAD/CAM specifications, scope of work specifications, address down time for the repair and replacement, address location and logistics of the components, identify necessary equipment for the renovation, generate instructions and generate a time schedule for the renovation.

In step 336, as an option, the user can install an imaging camera on the site to be renovated. The imaging camera generates data as “updated as-is scan data.” In this manner, the user can approve repair and replacement, improve a statement of use in stages as needed, and invoice and secure payment to the vendor. The module ends in step 338.

FIGS. 10A to 10C diagrammatically illustrate a heritage reconstruction module as a process flowchart. The process flowchart is sequentially presented in FIGS. 10A through 10C. FIGS. 12A and 12B diagrammatically illustrate a heritage site reconstruction process. These figures are discussed concurrently herein.

In FIG. 10A, block 350 initiates the heritage reconstruction module. In step 352, the system executes, as an initial process, the general process flowchart and acquires 3-D laser scanning data, imaging data and imaging device location at a reference viewpoint. Further, the acquisition of 3-D laser scanning includes geographic location or reference point location for the scanner-camera. This data is saved with the scanned data as “as-is scan dated” data. It is important in the heritage reconstruction module to date and time stamp the imaging data obtained at the heritage site. The as-is scan includes day and time of the scan in may include then current conditions of the site as noted in step 354. In step 356, optionally, the as-is scan-dated data may include environmental or ambient data such as lighting conditions or other factors that may affect the quality of the as-is scan-dated data. Referring to FIG. 12A, the reference point within the view of the scanning image camera refers to reference object 618 attached to post 616 placed along vertical line a′-a″ at the corner of the object “wall” being scanned. The object wall being scanned in FIG. 12A is a partially uncovered wall segment 610. This wall segment 610 has an uncovered left side run 611 leading to a corner block 706 and a right-side wall run 614. The wall segment and vertical wall section 612 has deteriorated and has not been identified or uncovered in the heritage site.

In FIG. 10A, and in step 358, the user may obtain some historical building schematics relevant to the heritage site. These historical building schematics may include BIM style virtual models for BIM components which are generally identified herein as “BIM-tools”. These BIM component tools may include BIM wall virtual elements including height, thickness and type of material, BIM wall corner component elements, doorway component elements including dimensions, height, width, doorjamb conditions, and door floor plate components. Street components would include material, subsurface structures, and thickness. Bath components would include depth of bath and size of the bathtub. Components for cooking and kitchen data can be obtained, sewer intake BIM model tools and sewer component and work place components such as inground vessels can also be obtained from similar historic sites as BIM tool schematics.

In step 360, the user initializes the component data tables for this historic H-site. Static component tables are utilized for certain BIM virtual model tools. These are typically walls and floors. Dynamic component data are the subject of movable people or substances. For example, dynamic component tables for doorways include the size of the opening and the height. Dynamic component tables for streets include the width and subsurface design elements. Dynamic component tables for sewers include size and type of fluid handled by the sewer. Dynamic tables for windows include typical size and light entryways.

In step 362, using the as-is scan-dated data, the user manually or the system automatically identifies the reference point on the site, which, in FIG. 12A, is reference point 618. The system automatically or with some minor adjustment by the user, identifies a wall corner as block 706 in FIG. 12A. The system identifies that wall corner by best fit image recognition software. The system also recognizes left side wall corner edge 702 and right-side corner edge 704 of right side wall segment 611. These are visual identifiable points are confirmed with a best fit software indicating a BIM virtual wall. The image recognition software utilizes BIM tools to locate wall corner BIM models for corner block 706 and matches the BIM model tools to the as scanned corner block 706. Multiple reference points are obtained during step 372 (see heritage reference points 702, 704 and 706).

In step 374, the system generates virtual data 1.0 with matching BIM model tools using the heritage reference points in the as-is scan-dated data image. In step 366, time passes and more of the site is uncovered and discovered. The system operator re-scans the heritage site. Multiple additional reference points are identified on scanned image of the site. The newly acquired scan data-dated is marked as newly acquired data which is different from the original scan data. The user or the system automatically applies the BIM tools earlier utilized. Additional BIM model tools for the site components are applied and the system generates virtual data 1.1.

In step 368, the user executes the viewer and editor module. The editor function compares the as-is scan dated-1 data with the virtual data 1.0 and the as-is scan dated-2 data and the virtual data 1.1 data. For example with respect to FIG. 12B, the virtual data would include the top height of the wall 650 which is projected a distance 652 above the left side wall run 611. Additional corner pieces 621, 622 are added to complete the wall and adding blocks 633 and 630.

Regarding step 638, modifications are made and temporarily saved until the BIM tools match the as-is scan data and the virtual data 1.0 and the virtual data 1.1. If a match is not obtained, then the edit-modify v-BIM is deleted in as being temporary. The system automatically uses best fit algorithms and the final data is saved as virtual data 2.0. The process ends at step 370.

In this manner, the user can design a process to uncover further aspects at the heritage archaeological site based upon nominal information obtained in the initially acquired as-is scan data shown in FIG. 12A. For example, the user may ascertain or guess that block 706 in FIG. 12A is a corner piece. The user then directs his activities to uncover further right-side wall elements, extending to the right-side wall segment 614. If significant right-side wall elements are located during the dig (not shown), the user can then virtually identify that the wall has a certain height 652 in FIG. 12B and therefore create a virtual wall segment. Once the wall segment is virtually identified along with a corner and right-side walls and left side walls, the user can seek to identify a doorway or entranceway for the occupant of the heritage site.

The primary static component is wall end point 702. The secondary static component is wall end 704. And the tertiary static component is corner block 706 or the corner edge at the terminal end of pole 616. From these, the virtual wall segment 650 and the wall height 652 can be virtually identified by the system.

Another explanation of the heritage BIM process uses first and second temporal 3-D scans obtained over first and second disparate time frames. A first compatible BIM is spatially aligned with the first temporal 3-D scan upon at least a primary and a secondary static component. The primary of first static component in FIG. 12A is the wall end point 702. By image recognition software, the system, can locate the second static component which is in FIG. 12A wall end 704. In this manner, the thickness of the wall is identified. The confirm that a “wall” is identified, edge detection and image recognition software detects the upper wall edge line on the left and right side of wall 611. This is further accomplished with best fit imagining algorithm software. For the second compatible BIM and the second temporal 3-D scan, the second virtual reality BIM data is spatially matched to the first virtual reality BIM data, the first and second static components are spatially matched in the second 3-D scan and a third or tertiary static component, that is corner block 706, is used. Dynamic component data is based upon the primary, secondary and tertiary static component data, 702, 704, 706, and the dynamic component data is an estimation of a fully functional BIM for the monitored heritage site. The fully functional BIM in FIG. 12B is virtual wall header 650 estimated to be a distance 652 above the ground plane. Wall segment 611 rises above the ground plane in the heritage site.

In the drawings, and sometimes in the specification, reference is made to certain abbreviations. The following Abbreviations Table provides a correspondence between the abbreviations and the item or feature.

Abbreviations Table

| | |
|---|---|
| ACQ | acquisition or obtaining data or information |
| Admin | Administrator |
| addr | address—typically an address, street, city, state, zip |
| alt. | ALT: alternate or optional path or step |
| API | application program interface |
| app | computer program enabled to access another program, |
| | typically stored on a smart phone or IE device |
| AR | augmented reality |
| ASP | application service provider—server on a network |
| auto | automatic, without manual activation, maybe a pre-set |
| | condition, set by the system operator, prior to use of |
| | functional program |
| AV | audio visual |
| B-customer | business customer |
| bd | board |
| BIM | building information model |
| Bus | Business |
| CAD | CAD-CAM, computer aided design, computer aided mfg. |
| CCU | Central Control Unit or Module |
| CD-RW | compact disk drive with read/write feature for CD disk |
| cmd | command |
| cntl | control or controller |
| Cntr | Center, as in Central Processing Center, either at a physical |
| | location, over distributed locations or virtual cloud-based |
| | centers of operation |
| comm. | communications, typically telecommunications |
| comp | computer having internet enabled communications module |
| CPU | central processing unit |
| DB | data base |
| dele | delete, as in delete data |
| desig | designated, as in “person designated to control view” |
| disp | display, typically data shown on a monitor or display |
| | screen of a computer-enabled device, may be an interactive |
| | data input screen displayed to users, or may be an output |
| | report displayed on the same screen, typically display a |
| | web page or display certain information. |
| displ | display, see above |
| doc | document |
| drv | drive, e.g., computer hard drive |
| DS | data storage |
| dyn | dynamic |
| e | encryption |
| e.g. | for example |
| em | email |
| equip | equipment |
| emp'ee | employee |
| emp'r | employer or potential employer |
| F or f | frequency |
| Fac | facility, same as processing plant, vessel, FPSO |
| | commercial property, heritage site |
| fnc | function, typically a computer function |
| func | function, typically a computer function |
| geo | geographic location or code (geo.loc. is GPS data) |
| GPS | geo positioning system and location (optionally time data) |
| h-link | hyper link to a certain webpage or landing page |
| hist | history, as in data history or telemetric history |
| I/O | input/output |
| id | identify or identification |
| ie or IE | Internet-enabled device, like a smart phone, |
| | tablet computer, computer, etc. |
| IP addr. | internet protocol address of internet enabled device |
| IR | infrared |
| K | 1,000 units, as in a 33K hertz signal |
| KPI | key performance indicator(s) |
| kypd | keypad or touch screen display acting as a keypad |
| kyBd | keyboard or a touch screen display function |
| loc | location |
| loc. ptr. | displayed location on a displayed map |
| m | meters |
| mbr | member |
| mem | memory |
| mess | message as in SMS or text message |
| mfg | manufacturing |
| mic | microphone or audio pickup device |
| mod | modify or modification |
| ntwk | network, namely a telecomm network, typically internet |
| | based network. A local area network is also possible. |
| obj | object, for example, a data object |
| opt | optional or alternative program or module |
| P&ID | piping and instrumentation diagram |
| pg. | page, typically a web page, may be a landing web page |
| pgm | program |
| ph | phone, namely an internet enabled phone, such as a smart |
| | phone |
| ph.no. | phone number |
| PII | personal identifying data, typically a customer name, |
| | address, phone number, SSN, cr.cd. or other financial |
| | data, etc. |
| proc | processor, typically a microprocessor |
| prop | property |
| pt. | point |
| Pty | party engaged in telecomm or internet enabled |
| | communications |
| P/W | password |
| pwr | power |
| re | regarding or relating to |
| reno | renovation or modification to facility or site |
| RQT | request |
| rev | review |
| Rpt | Report |
| Rt or R.T. | real time, may include day and time stamp data |
| sch | search |
| sec | security |
| sel | select |
| sess | session, as in telecomm session |
| sig cond | signal conditioner |
| smart ph | smart phone coupled to the internet |
| sms | text message |
| spkr | speaker or audio announcement device |
| SSN | social security number (“no.”) |
| stat | static |
| std | standard, typically protocol set by a group and accepted by |
| | the system operator |
| Svr | sever, as in web server or computer acting as a |
| | master system to display data over the Internet |
| sys | system |
| Sys Op | System Operator |
| t | time |
| t-out | the expiration of a time-out clock |
| t plus tx | an additional pre-set period of time added to a time-based |
| | trigger, for example, when a time-end-flag is created, the t |
| | plus tx, when tx = 3 sec., is the time stamp at time-end-flag |
| | plus 3 sec. |
| tbl | tablet computer |
| telecom | telecommunications system or network |
| temp mem | temporary memory, RAM, etc., not permanently stored |
| | data memory or data storage units |
| txr | transmitter—receiver device, maybe BLUETOOTH (tm), |
| | lan, wireless telecom network, or radio frequency |
| UPP | user's personal profile, for example an HC worker |
| | completes a UPP prior to inputting data about his or her HC |
| | application. |
| URL | Uniform Resource Locator or other network locator |
| VR | virtual reality |
| vs | versus |
| w/ | with |
| w/in | within |
| w/out | without |
| w/r/t | with respect to |

### Description of Typical System Features

The system described above is initially designed to operate over the Internet or, stated otherwise, is a cloud based processing and display system. However, the system and method can be re-configured to operate on a wide area network or a local area network. Once initialized, users access the central processing system (typically cloud based) with one or more Internet-enabled (IE) devices, such as, smart phone, cell phone with an APP, tablet computer, computer, or other IE device that is internet enabled. The APP (an access point) or internet portal permits the person to access the system. The system and method also operates with voice and AV data provided by the cloud-based server to IE devices remotely located at various geographically remote user locations.

The present invention relates processes data via computer systems, over the Internet and/or on a computer network (LAN or WAN), and computer programs, computer modules and information processing systems accomplish these services.

It is important to know that the embodiments illustrated herein and described herein below are only examples of the many advantageous uses of the innovative teachings set forth herein.

In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. In the drawings, like numerals refer to like parts or features throughout the several views.

The present invention could be produced in hardware or software, or in a combination of hardware and software, and these implementations would be known to one of ordinary skill in the art. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in the art.

The sequentially presented steps and modules discussed above can be reorganized to improve operating efficiency of the system and method. Stated otherwise, the order of the modules can be changed as needed without departing from the scope of the invention.

According to the inventive principles as disclosed in connection with the preferred embodiments, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer as would be known to one of ordinary skill in the art. The computer medium which may be used to hold or contain the computer program product, may be a fixture of the computer such as an embedded memory or may be on a transportable medium such as a disk, as would be known to one of ordinary skill in the art. Further, the program, or components or modules thereof, may be downloaded from the Internet of otherwise through a computer network.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, flash memory, floppy disk, disk drive memory, CD-ROM, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network, that allow a computer to read such computer readable information.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent exemplary embodiments of the invention and are therefore representative of the subject matter which is broadly contemplated by the present invention. It is further understood that the scope of the present invention fully encompasses other embodiments and that the scope of the present invention is accordingly limited by nothing other than the appended claims.

The claims appended hereto are meant to cover modifications and changes within the scope and spirit of the present invention.

What is claimed is:

1. A method for integrating substantially realtime telemeteric data into a building information model (“BIM”) presented as an augmented reality display or a virtual reality display to one or more users comprising:
obtaining one or more 3-D scans of a telemetric monitored facility from the group of monitored facilities including an industrial plant facility, an industrial processing platform, a commercial site, a floating production storage and offloading vessel, and a maritime vessel;
spatially aligning a compatible BIM with said one or more 3-D scans for said monitored facility and generating virtual reality BIM data which substantially spatially matches said monitored facility, said compatible BIM having data representative of: (a) at least one telemetric monitor associated with at least one process occurring in said monitored facility, and (b) at least two static components associated with said at least one process on said monitored facility;
obtaining dynamic component data representative of said at least one telemeteric monitor and representative of at least one controlled variable in said at least one process;
obtaining static component data representative of said at least two static components;
linking said dynamic component data and said static component data with said virtual reality BIM data;
displaying on said augmented reality display or said virtual reality display said virtual reality BIM data, said dynamic component data and said static component data, one or both of said dynamic component data and said static component data concurrently displayed with said virtual reality BIM data upon a user's command.

2. A method for integrating substantially realtime telemeteric data into a BIM as claimed in claim 1 generating said compatible BIM from a library of BIM data objects and, said at least two static components are included in said library of BIM data objects.

3. A method for integrating substantially realtime telemeteric data into a BIM as claimed in claim 2 wherein said dynamic component data represents a dynamic data object for one or both of said two static components included in said library of BIM data objects.

4. A method for integrating substantially realtime telemeteric data into a BIM as claimed in claim 1 wherein said compatible BIM includes data objects from a piping and instrumentation diagram (“P&ID”) for said monitored facility, said P&ID representing said static component data, said static component data including instrumentation component data and control component data, said P&ID further representing said dynamic component data, said dynamic component data including process flow data in said monitored facility, instrumentation status data in said monitored facility and control status data in said monitored facility, said control component data at least effecting said process flow data.

5. A method for integrating substantially realtime telemeteric data into a BIM as claimed in claim 3 wherein said, compatible BIM includes data objects from a piping and instrumentation diagram (“P&ID”) for said monitored facility, said P&ID representing said static component data, said static component data including instrumentation component data and control component data, said P&ID further representing said dynamic component data, said dynamic in said monitored facility and control status data in said monitored facility, said control component data at least effecting said process flow data.

6. A method for integrating substantially realtime telemeteric data into a BIM as claimed in claim 1 wherein said compatible BIM includes data objects from as-built plans of said monitored facility.

7. A method for integrating substantially realtime telemeteric data into a BIM as claimed in claim 5 wherein said compatible BIM includes data objects from as-built plans of said monitored facility.

8. A method for integrating substantially realtime telemeteric data into a BIM as claimed in claim 1:
wherein a first static component of said at least two static components is a pipe used in said at least one process, said first static component being pipe static component data;
said one or more 3-D scans of said monitored facility having scan data representative of an insulation over said pipe;
said one or more 3-D scans of said monitored facility having further scan data representative of a flange on said pipe;
obtaining thickness data of said flange based upon said further scan data;
obtaining one or both of an estimated outside diameter and an, estimated inside diameter of said pipe based upon the flange thickness data;
in said virtual reality BIM data, using a pipe BIM object data to represent said pipe;
updating said pipe static component data with said one or both of said estimated outside diameter and said estimated inside diameter of said pipe;
linking said dynamic component data with said pipe static component data for said at least one process occurring in said monitored facility.

9. A method for integrating substantially realtime telemeteric data into a RIM as claimed in claim 7:
wherein a first static component of said at least two static components is a pipe used in said at least one process, said first static component being pipe static component data;
said one or more 3-D scans of said monitored facility having scan data representative of an insulation over said pipe;
said one or more 3-D scans of said monitored facility having further scan data representative of a flange on said pipe;
obtaining thickness data of said flange based upon said further scan data;
obtaining one or both of an estimated outside diameter and an estimated inside diameter of said pipe based upon the flange thickness data;
in said virtual reality BIM data, using a pipe RIM object data to represent said pipe;
updating said pipe static component data with said one or both of said estimated outside diameter and said estimated, inside diameter of said pipe;
linking said dynamic component data with said pipe static component data for said at least one process occurring in said monitored, facility.

10. A method for integrating substantially realtime telemeteric data into a BIM as claimed in claim 9 wherein said dynamic component data is one of a plurality of said dynamic component data tables, at least one dynamic component data table including key performance indicator data for said monitored facility.

11. A method for integrating substantially realtime telemeteric data into a BIM as claimed in claim 1 wherein said dynamic component data represents a dynamic data object for one or both of said two static components; and including, overlaying on said virtual reality BIM, data an animated image of said dynamic component data.

12. A method for integrating substantially realtime telemeteric data into a BIM as claimed in claim 9 including overlaying on said virtual reality BIM data an animated image of said dynamic component data.

13. A method for integrating substantially realtime telemeteric data into a BIM as claimed in claim 1 including displaying, a first 3-D scan of said one or more 3-1) scans; measuring a virtual distance between at least two displayed points on said first 3-D scan to generate a virtual distance data representative of an actual distance and either (a) spatially aligning said compatible BIM with said first 3-D scan using said virtual distance data to generate virtual reality BIM data, or (b) storing said virtual distance data in one or both of said dynamic component data and said static component data wherein said virtual distance data is associated with one or both of said two static components.

14. A method for integrating substantially realtime telemeteric data into a BIM as claimed in claim 12 including displaying a first 3-D scan of said one or more 3-D scans; measuring a virtual distance between at least two displayed points on said first 3-D scan to generate a virtual distance data and either (a) spatially aligning said, compatible DIM with said first 3-D scan using said virtual distance data to generate virtual reality BIM data, or (b) storing said virtual distance data in one or both of said dynamic component data and said static component data wherein said virtual distance data is associated with one or both of said two static components.

15. A method for integrating substantially realtime telemeteric data into a BIM as claimed in claim 1 including providing a mobile detector operable to sense a condition on said monitored facility and generate acquired data on a first of said two static components; providing a telecommunications network, coupled to said mobile detector; and uploading said acquired data via said telecommunications network and importing the same as one or both of said dynamic component data and said static component data wherein the uploaded acquired data is associated with one or both of said two static components.

16. A method for integrating substantially realtime telemeteric data into a BIM as claimed in claim 15 including providing a mobile detector operable to sense a condition on said monitored facility and generate acquired data on a first of said two static components; providing a telecommunications network coupled to said mobile detector; and uploading said acquired data via said telecommunications network and importing the same as one or both of said dynamic component data and said static component data wherein the uploaded acquired data is associated with one or both of said two static components.

17. A method for producing and displaying an augmented reality display or a virtual reality display from a plurality of 3-D scans of a monitored facility, said monitored facility being one from a group of monitored facilities including an industrial plant facility, an industrial processing platform, a commercial site, a floating production storage and offloading vessel, and a maritime vessel, comprising:
obtaining one or more 3-D scans of said monitored facility represented as as-is data;
obtaining a compatible building information model (“BIM”) for said monitored facility, said compatible BIM having static component data matching static components visually represented in said as-is data, said compatible BIM having dynamic component data matching dynamic component data representative of at least one process occurring in said monitored facility;
spatially aligning said compatible HIM with said as-is data to generate virtual reality BIM data which substantially spatially matches said monitored facility;
said compatible BIM having, for each discrete static component data, a discrete static object link permitting a respective display of said discrete static component data when said static object link is activated in said compatible BIM;
said compatible BIM having, for said dynamic component data, a dynamic object link permitting display of said dynamic component data when said dynamic object link is activated in said compatible BIM;
concurrently displaying, on said augmented reality display or said virtual reality display, said virtual reality BIM data which includes said compatible BIM data, said dynamic component data and said static component data;
one or both of said dynamic component data and said static component data concurrently displayed with said virtual reality BIM data upon a user's command; and
displaying upon another user's command said as-is data with or without a concurrent display of said virtual reality BIM data;
thereby permitting views of (i) said as-is data; (ii) said virtual reality BIM data; (iii) said discrete static component data, and (iv) said dynamic component data for said one process in said monitored facility.

18. A method for producing and displaying an augmented reality display or a virtual reality display as claimed in claim 17 wherein said compatible BIM includes data objects from a piping and, instrumentation diagram (“P&ID”) for said monitored facility, said PAID representing said static, component data, said static component data including instrumentation component data and control component data, said P&ID further representing said dynamic component data, said dynamic component data including process flow data in said monitored facility, instrumentation status data in said monitored facility and control status data in said monitored facility, said control component data at least effecting said process flow data.

19. A method for producing and displaying, an augmented reality display or a virtual reality display as claimed in claim 18 wherein said compatible BIM includes data objects from as built plans of said monitored facility.

20. A method for producing and displaying an augmented reality display or a virtual reality display as claimed in claim 18:
wherein a plurality of static components are present in said compatible BIM and are visually represented in said as-is data,
wherein a first static component of said plurality of static components is a pipe, said first static, component being pipe static component data;
said as-is data having data representative of an insulation over said pipe;
said as-is data, having further data representative of a flange on said pipe;
obtaining thickness data of said flange based upon, said further data;
obtaining one or both of an estimated outside diameter and an estimated inside diameter of said pipe based upon the flange thickness data;
in said compatible BIM data, using a pipe BIM object data to represent said pipe;
updating said pipe static component data with said one or both of said estimated outside diameter and said estimated inside diameter of said pipe;
linking said dynamic component data with said pipe static component data for said at least one process occurring in said monitored facility.

21. A method for producing and displaying an augmented reality display or a virtual reality display as claimed in claim 18 wherein said dynamic component data is one of a plurality of said dynamic component data tables, at least one dynamic component data table including key performance indicator data for said monitored facility.

22. A method for producing and displaying an augmented reality display or a virtual reality display as claimed in claim 17 wherein said dynamic component data represents a dynamic data object for one or both of said two static components; and including overlaying on said virtual reality BIM data an animated image of said dynamic component data.

23. A method for producing and displaying an augmented reality display or a virtual reality display as claimed in claim 17 including displaying a first 3-D scan of said one or ore 3-D scans; measuring a virtual distance between at least two displayed points on said first 3-D scan to generate a virtual distance data and either (a) spatially aligning said compatible BIM with said first 3-D scan using said virtual distance data to generate virtual reality BIM data, or (b) storing said virtual distance data in one or both of said dynamic component data and said static component data wherein said virtual distance data is associated with one or both of said two static components.

24. A method for producing and displaying an augmented reality display or a virtual reality display as claimed in claim 17 including providing a mobile detector operable to sense a condition on said monitored facility and generate acquired data on a first of said two static components; providing a telecommunications network coupled to said mobile detector; and uploading said acquired data via said telecommunications network and importing the same as one or both of said dynamic component data and said static component data wherein the uploaded acquired data is associated with one or both of said two static components.

25. A method for producing and displaying an augmented reality display or a virtual reality display from a plurality of 3-D scans of a monitored facility, said monitored facility being one from a group of monitored facilities including an industrial plant facility, an industrial processing platform, a commercial site, a floating production storage and offloading vessel, and a maritime vessel, a mobile
detector operable to sense a condition on said monitored facility and generate acquired data, a telecommunications network coupled to said mobile detector, the method comprising:
obtaining one or more 3-D scans of said monitored facility represented as as-is data;
obtaining a compatible building information model (“BIM”) for said monitored facility, said compatible BIM having static component data matching static components visually represented in said as-is data, said compatible BIM having dynamic component data matching dynamic component data representative of at least one process occurring in said monitored facility;
spatially aligning said compatible BIM with said as-is data to generate virtual reality BIM data which substantially spatially matches said monitored facility;
said compatible BIM having, for each discrete static component data, a discrete static object link permitting a respective display of said discrete static component data when said static object link is activated in said compatible BIM;
said compatible BIM having, for said dynamic component data, a dynamic object link permitting display of said dynamic component data when said dynamic object link is activated in said compatible BIM;
uploading said acquired data via said telecommunications network and importing the same as one or both of said dynamic component data and said static component data wherein the uploaded acquired data is associated with one or both of said two static components;
concurrently displaying, on said augmented reality display or said virtual reality display, said virtual reality BIM data which includes said compatible BIM data, said dynamic component data and said static component data;
one or both of said dynamic component data and said static component data concurrently displayed with said virtual reality BIM data upon a user's command; and
displaying upon another user's command said as-is, data with or without a concurrent display of said virtual reality BIM data;
thereby permitting views of (i) said as-is data; (ii) said virtual reality BIM data; (iii) said discrete static component data, and (iv) said dynamic component data for said one process in said monitored facility.

26. A method for integrating temporal data into a building information model (“BIM”) presented as an augmented reality display or a virtual reality display to one or more users comprising:
obtaining at least a first and a second temporal 3-D scan over corresponding first and second disparate time frames of a temporally monitored facility from the group of monitored facilities including an industrial plant facility, an industrial processing platform, a commercial site, a floating production storage and offloading vessel, a maritime vessel, and a heritage site;
spatially aligning a first compatible BIM with said first temporal 3-D scan for said monitored facility based upon at least a primary and a secondary static component in both said first temporal 3-D scan and said first compatible BIM;
generating a first virtual reality BIM data which substantially spatially matches said monitored facility at said first disparate time frame based upon a best fit algorithm with said primary and secondary static, components;
said first compatible BIM having data representative of said primary and secondary static components and said monitored facility at said first disparate time frame;
spatially aligning a second compatible BIM with said second temporal 3-D scan and generating a second virtual reality BIM data which substantially spatially matches said monitored facility at said second disparate time frame and substantially spatially matches said first compatible BIM;
said second compatible BIM having data representative of at least a tertiary static component associated, with said monitored facility at said second disparate time frame;
generating dynamic component data based upon said primary, secondary, and
tertiary static component data, said dynamic component data being an estimation of a fully functional BIM for said monitored facility;
linking said dynamic component data and said primary, secondary and tertiary static component data with said second virtual reality BIM data;
displaying on said augmented reality display or said first and second virtual reality display said virtual reality BIM data, said dynamic component data and said static component data, one or both of said dynamic component data and said static component data concurrently displayed with said virtual reality BIM data upon a user's command.

27. An online system integrating substantially realtime telemeteric data into a building information model (“BIM”) presented as an augmented reality display or a virtual reality display to one or more users, comprising:
a first online memory store for point cloud data representing a 3-D scan data of a telemetric monitored facility from the group of monitored facilities including an industrial plant facility, an industrial processing platform, a commercial site, a floating production storage and offloading vessel, and a maritime vessel;
a second memory store for a compatible BIM for said monitored facility, said compatible BIM having a plurality of static component data tables, each static component data table matching a respective static component in said compatible BIM and visually represented in said 3-D scan data, said compatible BIM further having a plurality of dynamic component data tables, each dynamic component data table matching a respective process in a plurality of processes occurring in said monitored facility;
at least one of said plurality of dynamic component, data tables having respective process
telemetric data associated with said respective process, said at least one of said plurality of dynamic component data tables being a telemetric dynamic component data table;
means for spatially aligning said compatible BIM with said 3-D scan data to generate virtual reality BIM data which substantially spatially matches said 3-D scan data;
said static component data tables and said dynamic component data tables having respective data object links associated with corresponding static and dynamic components represented in said 3-D scan data;
whereby, upon display of said virtual reality BIM data and a user activation of a visual representation of the corresponding data object link for said static or dynamic component, the respective data object link causes concurrent display of said corresponding static or dynamic component table; and
whereby, upon further display of said virtual reality BIM data and a further user activation of a further visual representation of said dynamic component associated with said telemetric dynamic component data table, the respective data object link causes concurrent display of said corresponding telemetric dynamic component table.

28. An online system integrating telemeteric data into a BIM as claimed in claim 27 wherein said second memory store has said compatible BIM which includes data objects from a piping and instrumentation diagram (“P&ID”) for said monitored facility, said P&ID representing said static component data, said static component data including instrumentation component data and control component data, said P&ID further representing said dynamic component data, said dynamic component data including process flow data in said monitored facility, instrumentation status data in said monitored facility and control status data in said monitored facility, said control component data at least effecting said process flow data.

29. An online system integrating telemeteric data into a BIM as claimed in claim 27 wherein another dynamic component data table includes key performance indicator data for said monitored facility.
